(19) United States
(12) Patent Application Publication
(10) Pub. No.: US 2026/0364889 A1
(43) Pub. Date: Nov. 19, 2026

(54) THREE-DIMENSIONAL VOLUMETRIC PRINTING UTILIZING MEASUREMENT OF LIGHT SHEET PROFILE CREATED FROM PRINTING A CALIBRATION PART

(71) Applicant: QUADRATIC 3D, INC., CHARLESTOWN, MA (US)

(72) Inventors: SAMUEL N. SANDERS, ARLINGTON, MA (US); SARAH K. POOLE, CAMBRIDGE, MA (US); GAVIN R. KIEL, CAMBRIDGE, MA (US)

(21) Appl. No.: 19/752,317

(22) Filed: Jul. 23, 2026

Related U.S. Application Data
(63) Continuation of application No. PCT/US2025/013249, filed on Jan. 27, 2025.
(60) Provisional application No. 63/625,817, filed on Jan. 26, 2024.
(60) Provisional application No. 63/625,829, filed on Jan. 26, 2024.
(60) Provisional application No. 63/626,892, filed on Jan. 30, 2024.
(60) Provisional application No. 63/704,520, filed on Oct. 7, 2024.

(51) Int. Cl. B29C 64/393; B29C 64/129; B33Y 10/00; B33Y 50/02; B33Y 70/00

(52) U.S. Cl. CPC B29C 64/393; B29C 64/129; B33Y 10/00; B33Y 50/02; B33Y 70/00

(57) ABSTRACT

Methods and systems for use in printing one or more three-dimensional objects in a volume of a photohardenable composition are disclosed. One method includes determining one or more modifications to a set of preliminary printing settings by analyzing the profile of a light sheet used to print a three-dimensional object in the photohardenable composition. Another method includes printing a three-dimensional object and in a volume of photohardenable composition including use of a light sheet, and, during printing, analyzing variation in the profile of the light sheet used to print the object to determine changes to the printing settings for a subsequent print. Systems including a detector for capturing a light sheet profile during printing of a three-dimensional object being printed are also disclosed.

### CROSS-REFERENCE TO RELATED APPLICATIONS

This application is a continuation of International Application No. PCT/US2025/013249 filed Jan. 27, 2025 which International Application claims priority to U.S. Provisional Patent Application No. 63/625,817 of Quadratic 3D, Inc. filed Jan. 26, 2024, U.S. Provisional Patent Application No. 63/704,520 of Quadratic 3D, Inc. filed Oct. 7, 2024, U.S. Provisional Patent Application No. 63/625,829 of Quadratic 3D, Inc. filed Jan. 26, 2024, and U.S. Provisional Application No. 63/626,892 of Quadratic 3D, Inc. filed Jan. 30, 2024. Each of the foregoing applications is hereby incorporated herein by reference in its entirety for all purposes.

### TECHNICAL FIELD OF THE INVENTION

The present invention relates to the technical field of three-dimensional printing.

### BRIEF SUMMARY OF THE INVENTION

The present invention includes methods and systems useful in forming one or more three-dimensional objects in a volume of a photohardenable composition and in determining one or more printing settings for forming one or more three-dimensional objects in a volume of a photohardenable composition.

In accordance with one aspect of the present invention, there is provided a method comprising:
(a) printing a three-dimensional object in a volume of a photohardenable composition, wherein printing the three-dimensional object includes exposure of a series of selected locations in the volume to a light sheet and a selected projected optical image using a set of preliminary printing settings; and
(b) determining light sheet deflection profiles of the light sheet during printing the three-dimensional object using the set of preliminary printing settings.

The method can further include modifying one or more of the preliminary printing settings for use in subsequently printing one or more three-dimensional objects in the volume of the photohardenable composition to adjust the deflection of the light sheet in a subsequent print of one or more other three-dimensional parts.

In accordance with another aspect of the present invention, there is provided a method comprising:
(a) printing a three-dimensional object in a volume of a photohardenable composition, wherein printing the three-dimensional object includes exposure of a series of selected locations in the volume to a light sheet and a selected projected optical image using a set of preliminary printing settings;
(b) determining deflection of the light sheet during printing the three-dimensional object using the set of preliminary printing settings; and
(c) correlating the determined deflection of the light sheet to one or more of the preliminary printing settings to determine one or more modifications to the preliminary printing settings for use in subsequently printing one or more other three-dimensional objects in the volume of the photohardenable composition.

The method can further comprise subsequent printing of one or more three-dimensional objects in the volume of the photohardenable composition using the modified printing settings in which one or more of the preliminary printing settings have been modified to maintain or adjust light sheet deflection for the subsequent printing of the one or more three dimensional objects.

The method can further comprise repeating steps (b) and (c) for the one or more three-dimensional objects subsequently printed with the modified preliminary printing settings to determine light sheet deflection for the one or more subsequently printed part to determine any further changes to one or more of the modified printing settings before a next print. These steps can be repeated one or more times for refining printing settings.

In accordance with another aspect of the present invention, there is provided a method for use in determining settings for printing a three-dimensional object in a volume of a photohardenable composition, the method comprising:
(a) printing a calibration part in a volume of the photohardenable composition including exposure of a series of selected locations in the volume to a light sheet and a series of selected projected optical images using a set of preliminary printing settings;
(b) determining deflection of the light sheet during printing the calibration part with the preliminary settings;
(c) correlating light sheet deflection to the preliminary printing settings; and
(d) modifying one or more of the preliminary printing settings for use in printing one or more three-dimensional objects in the volume to adjust light sheet deflection during printing of the one or more three-dimensional objects.

The method can further comprise repeating steps (b) through (d) for the one or more three-dimensional objects subsequently printed with the modified preliminary printing settings to determine light sheet deflection for the one or more subsequently printed part to determine any further changes to one or more of the modified printing settings before a next print. These steps can be repeated one or more times for refining printing settings.

Optionally, step (a) can comprise (i) inducing a photopolymerization or cross-linking reaction at a selected location in the volume upon exposure to the light sheet and a selected projected optical images using a set of preliminary printing settings for the light sheet and the selected projected optical image, and optionally (ii) repeating step (i) one or more additional times to print the calibration part in the volume, wherein the selected location for a repeated step is different from a previous selected location and the selected projected optical image for a repeated step is the same as or different from a previous selected projected optical image.

More preferably, the photopolymerization or cross-linking reaction occurs at an intersection of the light sheet and the selected projected optical image at the selected location in the volume.

In accordance with another aspect of the present invention, there is provided a method of printing one or more three-dimensional objects in a volume of a photohardenable composition, the method comprising:
(a) determining one or more modifications to a set of preliminary printing settings used to print a calibration part in the photohardenable composition; and
(b) printing one or more three-dimensional objects in the photohardenable composition including exposure of a series of selected locations in the volume to a light sheet and a series of selected projected optical images using the modified set of preliminary printing settings.

The method can further comprise repeating step (a) for the one or more three-dimensional objects subsequently printed with the modified preliminary printing settings to determine one or more further modifications of the modified set of preliminary printing settings to determine any further changes to the modified set of preliminary printing settings before a next print. This protocol can be repeated one or more times for refining printing settings.

In accordance with another aspect of the present invention, there is provided a method of printing one or more three-dimensional objects in a volume of a photohardenable composition, the method comprising:
(a) determining one or more modifications to a set of preliminary printing settings used to print a calibration part in the photohardenable composition including exposure of a series of selected locations in the volume to a light sheet and a series of selected projected optical images using the set of preliminary printing settings wherein the modifications are correlated to variation of light sheet profiles (e.g., light sheet deflection profile) imaged during printing; and
(b) printing one or more three-dimensional objects in the photohardenable composition including exposure of a series of selected locations in the volume to a light sheet and a series of projected optical images using the modified preliminary printing settings.

The method can further comprise repeating step (a) for the one or more three-dimensional objects printed with the modified preliminary printing settings to determine one or more further modifications of the modified set of preliminary printing settings to determine any further changes to the modified set of preliminary printing settings before a next print. This protocol can be repeated one or more times for refining printing settings.

Determining one or more modifications to the set of preliminary printing settings can comprise, for example, monitoring variation of different aspects of the light sheet profile, for example, the brightness of the profile, the deflection of the profile, the width of the line, and other aspects. One aspect of the light sheet profile that is particularly useful for calibrating print settings is the light sheet deflection. For example, correlating the variation of the light sheet deflection during printing a calibration part in the volume of the photohardenable composition using the set of preliminary printing settings, correlating the changes in the profile of the light sheet to the set of preliminary printing settings, and adjusting one or more of the preliminary printing settings to create the modified preliminary printing settings for use in printing one or more three-dimensional objects in the photohardenable composition.

More preferably the modified preliminary printing settings are used to control light sheet deflection in printing one or more three-dimensional objects in the photohardenable composition.

In accordance with another aspect of the present invention, there is provided a method of printing one or more three-dimensional objects in a volume of a photohardenable composition, the method comprising:
(a) printing a three-dimensional part in the photohardenable composition including exposure of a series of selected locations in the volume to a light sheet and a series of selected projected optical images using the set of preliminary printing settings;
(b) monitoring variation of a profile of the light sheet of the light sheet during printing;
(c) correlating the variation of the light sheet profile during printing to the set of preliminary printing settings to determining one or more modifications to the set of preliminary printing setting, and
(d) printing one or more three-dimensional objects in the photohardenable composition including exposure of a series of selected locations in the volume to a light sheet and a series of projected optical images using the modified preliminary printing settings.

The method can further comprise repeating steps (b) and (c) for the one or more three-dimensional objects printed with the modified preliminary printing settings to determine variation of the light sheet profile for the one or more three-dimensional objects during printing to determine any further changes to one or more of the modified printing settings before a next print. This protocol can be repeated one or more times for refining printing settings.

In accordance with another aspect of the present invention, there is provided a method of printing one or more three-dimensional objects in a volume of a photohardenable composition, the method comprising:
(a) printing a calibration part in a volume of the photohardenable composition, wherein printing comprises intersecting a light sheet and one of a series of projected optical images at a series of selected locations in the volume using a set of preliminary printing settings;
(b) monitoring variation of a profile of the light sheet of the light sheet during printing,
(c) correlating the variation of the light sheet profile of light sheet to the set of preliminary printing settings to determine any one or more modifications to the set of preliminary printing settings used to print a calibration part; and
(c) printing one or more three-dimensional objects in the photohardenable composition including exposure of a series of selected locations in the volume to a light sheet and a series of projected optical images using the modified preliminary printing settings.

Determining one or more modifications to a set of preliminary printing settings can comprise, for example, monitoring variation of the light sheet profile, e.g., deflection of the light sheet during printing the calibration part in the volume of the photohardenable composition using the set of preliminary printing settings, correlating the variation of the light sheet, profile e.g., light sheet deflection during printing the calibration part in the volume of the photohardenable composition using the set of preliminary printing settings, and adjusting one or more of the preliminary printing settings to create modified preliminary printing settings for use in printing one or more three-dimensional objects in the photohardenable composition.

In accordance with another aspect of the present invention, there is provided a volumetric 3D printing system comprising:
(a) a volumetric 3D printer including a container for containing a volume of a photohardenable composition, light sheet optics for directing a light sheet to a selected location in the volume of the photohardenable composition, projection optics for projecting a selected optical image to the selected location in the volume to print one or more three-dimensional objects in a volume of the photohardenable composition including exposure of a series of selected locations in the volume to a light sheet and a series of selected projected optical images using a selected set of printing settings;
(b) a controller for controlling the printer for printing the one or more three-dimensional objects using the set of selected printing settings; and
(c) a detector for determining variations in the profile of the light sheet (e.g., light sheet deflection of the light sheet) at a selected location upon exposure of the photohardenable composition to the light sheet and a selected projected optical image at the selected location.

In accordance with another aspect of the present invention, there is provided a system for monitoring the profile of a light sheet passing through a volume of a photohardenable composition, the system comprising:
a container for holding the volume of the photohardenable composition having a light sheet entry side and an opposite light sheet exit side, wherein the container is oriented for the light sheet to pass through the light sheet entry side of the container, preferably at an angle of 90 degrees,
a light blocking member that is at least coextensive with, and proximate to, the exit side of the container, wherein the light blocking member is parallel to the light sheet exit side of the container and includes an aperture positioned for passage of the light sheet exiting the container therethrough, the aperture being sized to allow passage of the light sheet with maximal distortion arising from passage of the light sheet through the photohardenable composition and to minimize passage of back-reflected light sheet into the container through the aperture,
a screen spaced from the blocking member and oriented parallel thereto, the screen being in path of the light sheet passing through the aperture,
a lens positioned in the path of the light sheet exiting the container between the light blocking member and the screen, wherein the lens is preferably slightly tilted to prevent or minimize light sheet back-reflection from passing back through the aperture, and
a camera for capturing the profile of the light sheet on the screen.

In accordance with another aspect of the present invention, there is provided a system for monitoring the profile of a light sheet passing through a volume of a photohardenable composition, the system comprising:
a container for holding the volume of the photohardenable composition having a light sheet entry side and an opposite light sheet exit side, wherein the container is oriented for the light sheet to pass through the light sheet entry side of the container, preferably at an angle of 90 degrees,
a beam splitter in the path of the light sheet exiting the exit side of the container, the beam splitter being spaced from the light sheet exit side of the container and being of adequate size to facilitate reflection of a maximally distorted light sheet,
a beam dump spaced from the light sheet exit side of the container and in the light path of light transmitted by the beam splitter,
a screen spaced from and parallel to the path of the light sheet exiting the exit side of the container and positioned to be in the path of light reflected by the beam splitter, and
a camera for capturing the profile of the light sheet on the screen.

In accordance with another aspect of the present invention, there is provided a system for monitoring the profile of a light sheet passing through a volume of a photohardenable composition, the system comprising:
a container for holding the volume of the photohardenable composition having a light sheet entry side and an opposite light sheet exit side, wherein the container is oriented for the light sheet to pass through the light sheet entry side of the container, preferably at an angle of 90 degrees,
a screen spaced from the light sheet exit side of the container and oriented parallel thereto,
a beam splitter located between the light sheet exit side of the container and the screen, the beam splitter being of and being of adequate size to facilitate reflection of a maximally distorted light sheet,
a beam dump in the path of light sheet light reflected by the beam splitter, the beam dump being spaced from the beam splitter, and
a camera for capturing the profile of the light sheet on the screen.

As used herein, the term “deflection” refers to one or more changes in the light sheet profile compared to the profile of the light sheet when a part is not printing in the resin. Such changes to the light sheet profile can result in one or more changes in one or more light sheet parameters, which include the spatial extent of the transmitted light sheet, the brightness of the transmitted light sheet, the width of the transmitted light sheet, or various other measurable parameters. This information can be used to either monitor the printing process, for quality control purposes, or to compare to known standard print settings around a calibration part to result in a modified print setting for a given resin.

“Calibration part” and “preliminary three-dimensional object” may be used herein to refer to a three-dimensional object printed for use in evaluating the printing settings used to produce the three-dimensional object and/or determining one or more printing settings modifications thereto. A calibration part may be of any size and/or shape. For example, a calibration part may be the intended three-dimensional object to be printed, or an object having a size and/or shape that is different from the intended part to be printed. While a calibration part may be of any size and/or shape, it may be desirable for a calibration part to have small dimensions, e.g., of 10 mm×10 mm×10 mm or less (e.g., 0.25 mm×0.25 mm×0.25 mm, 3 mm×3 mm×3 mm, 7 mm×7 mm×7 mm), to minimize resin use in the determining one or more printing setting modifications. However, other smaller or larger sizes can alternatively be selected.

Forming or formation of one or more three-dimensional objects in a volume of a photohardenable composition may also be referred to herein as “printing”.

A photohardenable composition may also be referred to herein as a “resin” or “printing resin”.

A three-dimensional object may also be referred to herein as a “three-dimensional part” or a “part”.

The foregoing, and other aspects and embodiments described herein and contemplated by this disclosure all constitute embodiments of the present invention.

It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

It is to be understood that both the foregoing general description and the following detailed description are exemplary and explanatory only and are not restrictive of the invention as claimed.

Other embodiments will be apparent to those skilled in the art from consideration of the description and drawings, from the claims, and from practice of the invention disclosed herein.

### BRIEF DESCRIPTION OF THE DRAWINGS

In the drawings,

FIG. 1 schematically represents a top-view of an example of volumetric 3d printing of a calibration part depicting light sheet deflection during printing the calibration object in a volume of a photohardenable composition.

FIG. 2 schematically depicts an example of a volumetric 3D printing system of the present invention.

FIGS. 3A and 3B schematically represent examples of embodiments of various aspects of the present invention.

FIGS. 4A, 4B, and 4C depict images from printing three separate three-dimensional objects in a photohardenable composition using a set of preliminary printing settings including three different printing exposure times.

FIG. 5 schematically depicts an example of an embodiment of a method in accordance with the present invention, showing the direction of print progression, with a calibration part being printed before adjusting the printing time exposure and printing a three-dimensional object in the same volume of a photohardenable composition without removing the calibration part.

FIG. 6 depicts a top view of a schematic representation of an example of a system for monitoring the profile of a light sheet of the present invention.

FIG. 7 depicts a top view of a schematic representation of an example of a system for monitoring the profile of a light sheet of the present invention.

FIG. 8 depicts a top view of a schematic representation of an example of a system for monitoring the profile of a light sheet of the present invention.

FIG. 9 is a flowchart showing steps of an embodiment of a method in accordance with the present invention.

FIG. 10A shows a photograph of a profile of a light sheet determined by an embodiment of a method in accordance with the present invention.

FIG. 10B shows a copy of the photograph of FIG. 10A for which the color has been inverted for clarity of presentation. FIG. 10C shows the photograph of FIG. 10B marked to illustrate an example of a number of ID arrays used for determining the intensity value (L) along the x-direction at successive y-locations in the printing volume.

FIG. 11A shows the photograph of FIG. 10A of from an embodiment of a method of the present invention that has been marked to show the baseline location of the light sheet before printing and the deflection distance (x₀) offset from the baseline location after printing a cross-sectional slice of the object being printed.

FIG. 11B shows the line brightness L as a function of x for a single 1D array as shown in FIG. 11A. A standard Gaussian function is fitted to the 1D array and returns the parameters H, A, σ, and x₀, which define the background subtraction, maximum brightness amplitude, line width, and line position with respect to the baseline, respectively. A, σ, and x₀ are relevant to FIG. 9 and FIG. 12.

FIG. 12 graphically represents the data point for the maximum deflection (measured in pixels) of a light sheet and the brightness of the deflected light sheet at the maximum deflection value for each image taken of the light sheet profile along the x-direction during the print of a calibration object (starting with image #0 at start of the print and progressing to the end of the print of the object).

The attached figures are simplified representations presented for purposes of illustration only; the actual structures may differ in numerous respects, particularly including the relative scale of the articles depicted and aspects thereof.

For a better understanding of the present invention, together with other advantages and capabilities thereof, reference is made to the following disclosure and appended claims in connection with the above-described drawings.

### DETAILED DESCRIPTION OF THE INVENTION

Various aspects and embodiments of the present inventions will be further described in the following detailed description.

The present invention relates to methods and systems for use in printing one or more three-dimensional objects in a volume of a photohardenable composition.

In accordance with another aspect of the present invention, there is provided a method comprising:
(a) printing a three-dimensional object in a volume of a photohardenable composition, wherein printing the three-dimensional object includes exposure of a series of selected locations in the volume to a light sheet and a selected projected optical image using a set of preliminary printing settings; and
(b) determining deflection of the light sheet during printing the three-dimensional object using the set of preliminary printing settings.

The method can further include adjusting one or more of the preliminary printing settings for use in subsequently printing one or more three-dimensional objects in the volume of the photohardenable composition for reducing any determined deflection.

In accordance with another aspect of the present invention, there is provided a method comprising:
(a) printing a three-dimensional object in a volume of a photohardenable composition, wherein printing the three-dimensional object includes exposure of a series of selected locations in the volume to a light sheet and a selected projected optical image using a set of preliminary printing settings;
(b) determining deflection of the light sheet during printing the three-dimensional object using the set of preliminary printing settings;
(c) correlating the determined deflection of the light sheet to one or more of the preliminary printing settings to determine a modified set of printing settings for use in subsequently printing one or more three-dimensional objects in the volume of the photohardenable composition.

A modified set of printing settings will typically include the set of preliminary printing settings in which one or more of the printing settings has been adjusted to maintain or adjust the deflection of the light sheet determined in step (b) during subsequent printing of the one or more three-dimensional objects in the volume.

Printing settings may include one or more of printing exposure time for a given selected location, power level of a projector included in generating the selected projected optical image for the given selected location, power level of a light sheet generator included in generating the light sheet for the given selected location, thickness of the light sheet for the given selected location.

The method can further comprise subsequent printing of one or more three-dimensional objects in the volume of the photohardenable composition using the modified printing settings in which one or more of the preliminary printing settings have been modified to maintain or adjust light sheet deflection for the subsequent printing of the one or more three dimensional objects.

The method can further comprise repeating steps (b) and (c) for the one or more three-dimensional objects subsequently printed with the modified preliminary printing settings to determine light sheet deflection for the one or more subsequently printed part to determine any further changes to one or more of the modified printing settings before a next print. This protocol can be repeated one or more times for refining printing settings.

Variation in light sheet deflection from run-to-run can be used to assess run-to-run printing consistency for three-dimensional objects printed in one or more reuses of the photohardenable composition.

The method can further comprise maintaining the light sheet deflection within a selected range for one or more reuses of the photohardenable composition to print three-dimensional objects.

It can be desirable to maintain light sheet deflection within a selected range for run-to-run prints of three-dimensional objects in a given photohardenable composition to improve run-to-run printing consistency for the three-dimensional object(s) printed.

In accordance with another aspect of the present invention, there is provided a method for use in determining settings for printing a three-dimensional object in a volume of a photohardenable composition, the method comprising:
(a) printing a calibration part in a volume of the photohardenable composition including exposure of a series of selected locations in the volume to a light sheet and a series of selected projected optical images using a set of preliminary printing settings;
(b) determining deflection of the light sheet during printing the calibration part with the preliminary settings;
(c) correlating light sheet deflection to the preliminary printing settings; and
(d) modifying one or more of the preliminary printing settings for use in printing one or more three-dimensional objects in the volume to adjust light sheet deflection during printing the one or more three-dimensional objects.

Optionally, step (a) can comprise (i) inducing a photopolymerization or cross-linking reaction at a selected location in the volume upon exposure to the light sheet and a selected projected optical images using a set of preliminary printing settings for the light sheet and the selected projected optical image, and optionally (ii) repeating step (i) one or more additional times to print the calibration part in the volume, wherein the selected location for a repeated step is different from a previous selected location and the selected projected optical image for a repeated step is the same as or different from a previous selected projected optical image.

More preferably, the photopolymerization or cross-linking reaction occurs at an intersection of the light sheet and the selected projected optical image at the selected location in the volume.

Preferably the modified set of printing settings is selected to maintain or adjust light sheet deflection within a selected range during printing of the one or more three-dimensional objects in the volume.

In accordance with another aspect of the present invention, there is provided a method of printing one or more three-dimensional objects in a volume of a photohardenable composition, the method comprising:
(a) determining one or more modifications to a set of preliminary printing settings used to print a calibration part in the photohardenable composition; and
(b) printing one or more three-dimensional objects in the photohardenable composition including exposure of a series of selected locations in the volume to a light sheet and a series of projected optical images using the modified set of printing settings.

In accordance with another aspect of the present invention, there is provided a method of printing one or more three-dimensional objects in a volume of a photohardenable composition, the method comprising:
(a) determining one or more modifications to a set of preliminary printing settings used to print a calibration part in the photohardenable composition including exposure of a series of selected locations in the volume to a light sheet and a series of selected projected optical images using the set of preliminary printing settings wherein the modifications are correlated to variation of a light sheet profile (e.g., a light sheet deflection profile of the light sheet) during printing; and
(b) printing one or more three-dimensional objects in the photohardenable composition including exposure of a series of selected locations in the volume to a light sheet and a series of projected optical images using the modified preliminary printing settings.

Determining one or more modifications to the preliminary printing settings can comprise monitoring variations in the profile of the light sheet (e.g., a light sheet deflection profile of the light sheet) during printing the calibration part in the volume of the photohardenable composition using the set of preliminary printing settings, correlating the variations in the profile of the light sheet to the set of preliminary printing settings, and adjusting one or more printing settings to create the modified set of printing settings, in which one or more of the preliminary printing settings have been modified, for use in printing the one or more three-dimensional objects in the photohardenable composition.

In accordance with another aspect of the present invention, there is provided a method of printing one or more three-dimensional objects in a volume of a photohardenable composition, the method comprising:
(a) printing a three-dimensional part in the photohardenable composition including exposure of a series of selected locations in the volume to a light sheet and a series of selected projected optical images using the set of preliminary printing settings;
(b) monitoring variation of a light sheet profile of the light sheet during printing;
(c) correlating the variation of the profile of the light sheet light to the set of preliminary printing settings to determining one or more modifications to the set of preliminary printing setting, and
(d) printing one or more three-dimensional objects in the photohardenable composition including exposure of a series of selected locations in the volume to a light sheet and a series of projected optical images using the modified preliminary printing settings.

The method can further comprise repeating steps (b) and (c) for the one or more three-dimensional objects printed with the modified preliminary printing settings to determine variation of the light sheet profile during printing of the one or more three-dimensional objects to determine any further changes to one or more of the modified printing settings before a next print. This protocol can be repeated one or more times for refining printing settings.

More preferably the modified preliminary printing settings are used to control light sheet deflection in printing one or more three-dimensional objects in the photohardenable composition.

In accordance with another aspect of the present invention, there is provided a method of printing one or more three-dimensional objects in a volume of a photohardenable composition, the method comprising:
(a) printing a calibration part in a volume of the photohardenable composition, wherein printing comprises intersecting a light sheet and one of a series of projected optical images at a series of selected locations in the volume using a set of preliminary printing settings;
(b) monitoring variation of a profile of the light sheet during printing,
(c) correlating the variation of the profile of light sheet to the set of preliminary printing settings to determine any one or more modifications to the set of preliminary printing settings used to print a calibration part; and
(d) printing one or more three-dimensional objects in the photohardenable composition including exposure of a series of selected locations in the volume to a light sheet and a series of projected optical images using the modified preliminary printing settings.

The method can further comprise repeating steps (b) and (c) for the one or more three-dimensional objects printed with the modified preliminary printing settings to determine variation of the light sheet profile for the one or more printed three-dimensional objects to determine any further changes to one or more of the modified printing settings before a next print. This protocol can be repeated one or more times for refining printing settings.

In the methods described herein, the modified preliminary printing settings can be used to control or adjust variation of the light sheet profile, e.g., light sheet deflection, in printing one or more three-dimensional objects in the photohardenable composition.

In the methods described herein, a three-dimensional object is preferably suspended in the volume of the photohardenable composition during printing. More preferably, the one or more three-dimensional objects remain at a fixed position or are minimally displaced (e.g., by a minimal amount that is acceptable for producing the intended part geometry during the time interval required to print the part in the unpolymerized or unhardened photohardenable composition) during printing.

The various aspects of the present invention described herein are useful with a freshly prepared photohardenable composition. The various aspects of the present invention described herein are also useful with reuse of a photohardenable composition.

While a freshly prepared photohardenable composition can be readily-characterized, which can facilitate the selection of desirable preliminary printing settings for the photohardenable composition, there can be instances in which one or more of the preliminary sets of printing settings so determined can benefit from further adjustment or refinement.

The various aspects of the present invention described herein are also useful and particularly advantageous for use with a photohardenable composition that is not used when freshly prepared, e.g., a photohardenable composition which may have undergone change(s) that affect one or more of the printing performance characteristics thereof prior to use for printing. A photohardenable composition and/or the performance characteristics thereof for printing may change, for example, due to storage under conditions that may result in changes in the photohardenable composition (also referred to herein as a “stored photohardenable composition”), or because it has been previously used or recovered for reuse from a volume in which one or more 3D objects have previously been printed some previous number of times (also referred to as a “reused photohardenable composition”). Without the present invention, if a photohardenable composition has been stored under conditions that may cause changes in the photohardenable composition and/or the performance characteristics thereof, suitable printing settings are determined by trial and error since the stored or reused photohardenable composition will typically be different from the photohardenable composition as freshly made. For example, printing several build volumes at different printer settings and comparing part quality to determine the best settings. However, this process consumes considerable time and material, and is subject to interpretation of the user, e.g., interpreting whether there is too much (which can result, for example, in overcured objects with compromised resolution) or too little polymerization occurring (which can result, for example, in undercured objects with inadequate firmness).

The present invention includes methods and systems for calibrating and/or adjusting one or more of the printing settings for printing in a given photohardenable composition. By calibrating and/or adjusting one or more of the printing settings for printing a part, especially before each use of a stored or reused printing resin, more consistent parts can be obtained, even if photohardenable composition has undergone changes that may otherwise affect how it prints.

The present invention also includes methods and systems for forming or printing one or more three dimensional objects using one more modified printing settings selected based on variation of the profile of a light sheet during forming or printing an initial part or object using a set of preliminary printing settings.

In the methods and systems described herein, printing settings may include one or more of printing exposure time for a given selected location, power level of a projector included in generating the selected projected optical image for the given selected location, power level of a light sheet generator included in generating the light sheet for the given selected location, thickness of the light sheet for the given selected location. Printing settings can include other variable printing parameters.

Printing settings which can be particularly useful for varying in volumetric printing to adjust or maintain the desired degree of cure at a selected location include, but are not limited to, printing exposure time for a given selected location, power level of an excitation light to which a selected location is exposed (e.g., in a method or system including a light sheet and a projected optical image, the power level(s) thereof for the given selected location), and thickness of the light sheet for the given selected location

Modified printing settings will typically include the set of preliminary printing settings in which one or more of the printing settings is adjusted to maintain or adjust variation of the profile of the light sheet, e.g., deflection of the light sheet, during subsequent printing of the one or more three-dimensional objects in the photohardenable composition.

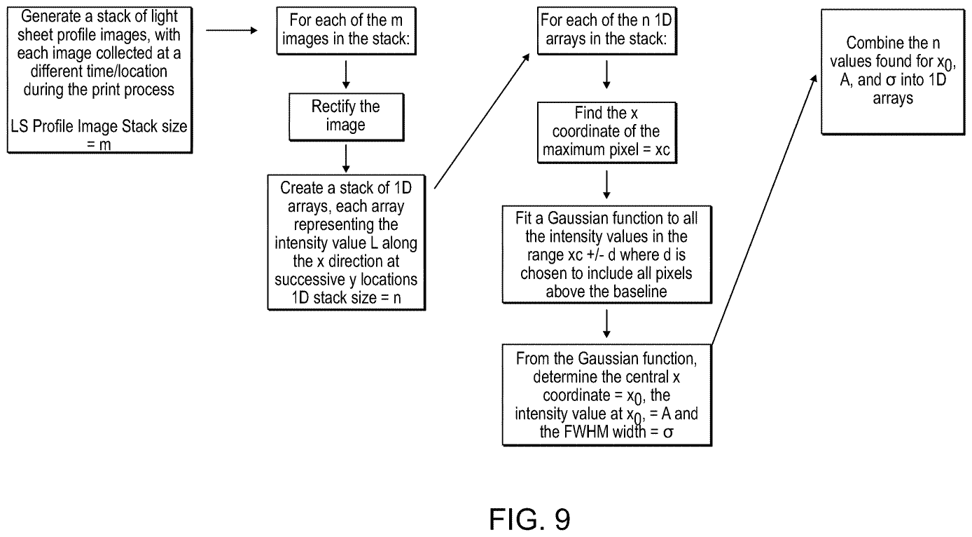

An example of a flowchart of an example of a preferred light sheet profile image processing method is provided in FIG. 9.

A number, m, of light sheet profile images are created during the process of printing a three-dimensional part or object in a volume of a photohardenable including exposure of a series of selected locations in the volume to a light sheet and a selected projected optical image using a set of preliminary printing settings. The stack of images shows the light sheet profile at different moments in time during printing the part or object. The light sheet profile images are collected preferably at different times/locations that are equally spaced. Preferably the images are collected at a high frequency for enhancing the information that can be extracted from the data.

Each of the images collected are preferably rectified by well-known techniques used in image processing. This can be useful in a system when the camera is positioned askew to the screen where the light sheet lands. Preferably, it is desirable for the light sheet to land vertically on the pixel grid for analysis purpose.

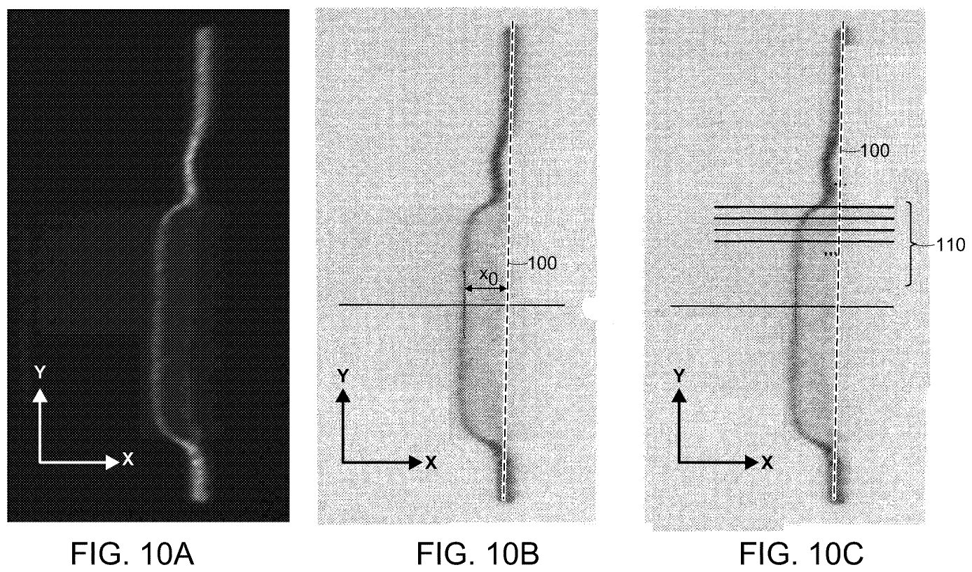

An example of a photograph of a light sheet profile image, that has been rectified, is shown inf FIG. 10A. FIG. 10B shows a copy of the photograph of FIG. 10A for which the color has been inverted for convenience. FIG. 10B identifies x₀ for the 1D image shown in FIG. 10A. The light sheet baseline 100 is also identified.

A number of one-dimensional (1D) arrays, n, is created for each of the light sheet profile images that are collected. Each of the 1D arrays represents the intensity value, L, of the light sheet along the x-direction, at each of the successive y locations. The number of 1D arrays for an image and the stack of 1D arrays is preferably as long as the image is tall. For example, if the image of the whole light sheet is W×H=500×1000 pixels, then n=1,000. “n” can be dictated by the camera's resolution.

FIG. 10C shows the photograph of FIG. 10B marked to illustrate an example of the orientation of a number of ID arrays 110 used for determining the intensity value (L) along the x-direction at successive y-locations in the printing volume.

Each of the 1D arrays is analyzed to determine the x coordinate of the pixel in the image of maximum brightness. (In FIG. 9, the coordinate of the maximum brightness pixel in the array is designated x_{c}.)

A standard Gaussian function is fitted to the 1D array and returns the parameters H, A, σ, and x₀, which define the background subtraction, maximum brightness amplitude, line width, and line position with respect to the baseline, respectively.

For each image there is an x_{c}, A and σ value.

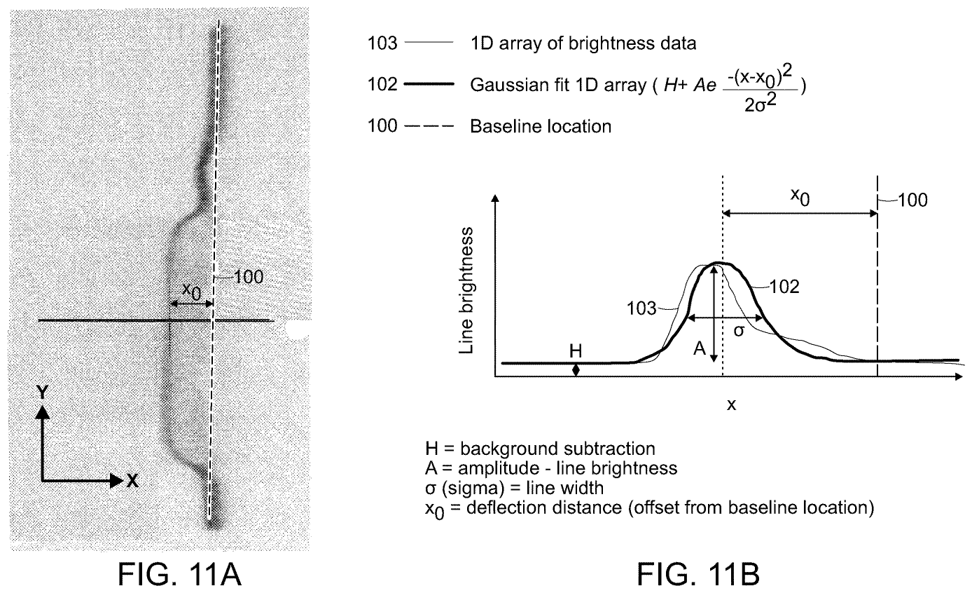

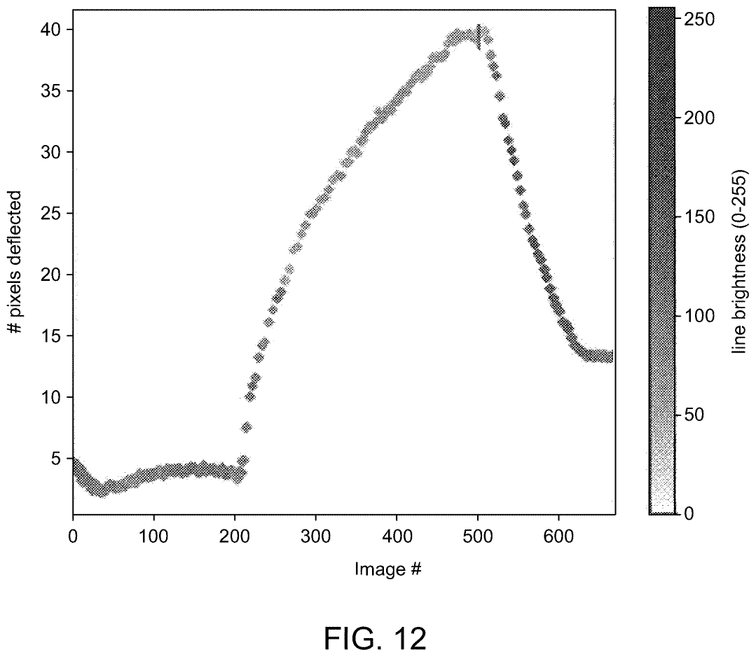

FIG. 12 shows the maximum x₀ values for each image obtained from the analysis process outlined in FIG. 9 and FIG. 11 chronologically for each image captured during the print. For each array with the maximum x₀ value, the brightness A is represented by the color intensity of the datapoint, and the line width σ is represented by the size of the data point. The vertical line near image 500 represents the datum with the maximum deflection distance for the entire print.

Following is a non-limiting example for iteratively correlating light sheet deflection to printing settings for a photohardenable calibration. Such correlation can be carried out, for example, for a photohardenable composition, e.g., on a formulation-on one or more of a formulation-by-formulation basis, on a bath-by-batch bases, on a container-by-container basis, on a run-by-run basis, on a use-reuse basis.

A non-limiting example of a method using light sheet deflection for calibration of printing settings for printing in a photohardenable composition for correlating light sheet profile variation, e.g., light sheet deflection, to a given set of printing settings includes:
(step 1) printing a calibration part, e.g., a 1 mm×1 mm×1 mm cube, in a photohardenable composition using the given set of printing settings. As discussed above, a use of a small calibration part size is preferably used to minimize resin use.
(step 2) determining the maximum deflection distance measured for printing the calibration part;
   (a) if the maximum deflection distance is within a selected range, the given printing settings and photohardenable composition are suitable for continued use for printing new parts in the given photohardenable composition with the given printing settings. A selected range. For example, a deflection range distance can be, for example 10-12 pixels. Alternatively the distance can be stated in mm or other measurement unit.
   (b) if the maximum deflection distance is outside of the selected range and the calibration has already been conducted a number of times before without an acceptable result (e.g., 3-10 times), printing in the same resin sample should be halted.
   (c) if the maximum deflection distance is outside of the selected range and the number of calibration runs is less than a selected maximum, e.g., 10 or less, one or more of the printing parameters is adjusted. Print speed can be a useful parameter to change in this regard. It the resin is one without prior use history, a series of test runs of printing in the resin at different print speeds can be generated, for providing multiplier to use in altering the print speed in the set of preliminary printing settings for an iterative calibration run to determine any further modifications of the printing settings.

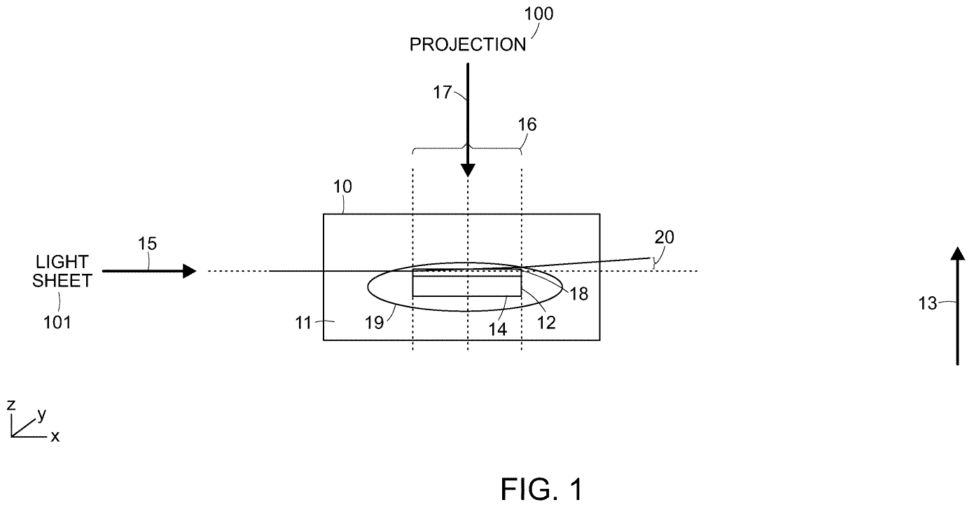

A top-view of an example of a diagram of a volumetric 3D printer useful in methods and systems of the present invention is shown in FIG. 1. As depicted, the volumetric 3D printer includes a container 10 that includes a volume of a printing resin 11 in which a three-dimensional object 12 is printed. While the figure depicts printing a single three-dimensional object, optionally one or more three-dimensional objects can be printed in the volume during the same print run. (Optionally, to minimize resin use, the object printed can be a small calibration part, e.g., a 7 mm×7 mm×7 mm or 3 mm×3 mm×3 mm cube, 1 mm×1 mm×1 mm, 0.25 mm×0.25 mm×0.25 mm. Other sizes can also be used.) The direction of the progression 13 of the printing of the three-dimensional object for the depicted example is also shown, with a first printed side or face 14 of the three-dimensional object 12 being identified.

In the depicted example, the light sheet 101 enters the container 10 from the left and is directed through the volume along the light sheet axis 15 at a selected location in the volume and exits the opposite side of the container. A projection 100 comprising a selected projected optical image 16 composed of one or more projection rays 16 is directed along the direction of the projection axis 17 to the selected location. Preferably the selected projected optical image and light sheet intersect at the selected location to induce a polymerization or cross-linking reaction at the selected location for forming a cross-sectional slice of the object being printed. This can be repeated at a series of selected locations with other selected optical images until the object is partially or fully formed. The selected projected optical image is typically a sequential cross-sectional slice of the object being printed. Preferably the selected projected optical image is orthogonal to the projection axis. Preferably the light sheet and projected optical image intersect in a coplanar manner at the selected location.

While not wishing to be bound by theory, because the polymerization or cross-linking reaction can produce heat and/or increases the density of the photohardenable composition, it is believed that such heat and/or density increases cause the refractive index of the photohardenable composition to vary temporarily and/or spatially. A depiction of an example of such altered refractive index region that can result from such heat and/or density increase is identified by reference numeral 19 in FIG. 1. In volumetric 3D printing, refractive index inhomogeneities can be detrimental because they typically distort the incident light. Such distortion can lead to a decrease in the accuracy of the object being printed and/or to optical artifacts that cause undesirable features, including, but not limited to, for example, surface roughness. However, here we take advantage of this phenomenon to achieve a measurable quantity for the rate of polymerization as it varies between various printing batches. We use this distortion of the light as a proxy for rate of cure and can use it to maintain or adjust print settings to maximize print consistency and quality.

When a light sheet is including in printing, the change in propagation direction as a result of refractive index distortion or inhomogeneities is referred to herein as “light sheet deflection”. Such change in propagation direction of the light sheet, or light sheet deflection is schematically represented in FIG. 1 by reference numeral 20. Many parameters that could be used to predict the ideal print settings can be determined from analyzing the profile of a deflected light sheet, including but not limited to the deflected distance, the light intensity variation over the profile of a deflected light sheet, the shape of the light sheet deflection, the width of the profile of the deflected light sheet, and others.

A determination of light sheet deflection can be made at any point in the progress of printing of a part. For example, light sheet deflection can be determined when a part is partially or fully printed. The determination is made from the most recently printed slice of the object 18 at the time the determination is made 18. Preferably the determination is made at the completion of printing the part.

In accordance with another aspect of the present invention, there is provided a volumetric 3D printing system comprising:
(a) a volumetric 3D printer including a container for containing a volume of a photohardenable composition, light sheet optics for directing a light sheet to a selected location in the volume of the photohardenable composition, projection optics for projecting a selected optical image to the selected location in the volume to print one or more three-dimensional objects in a volume of the photohardenable composition including exposure of a series of selected locations in the volume to a light sheet and a series of selected projected optical images using a set of selected printing settings;
(b) a controller for controlling the printer for printing the one or more three-dimensional objects using the set of selected printing settings; and
(c) a detector for determining light sheet deflection of the light sheet at a selected location upon exposure of the photohardenable composition to the light sheet and a selected projected optical image at the selected location.

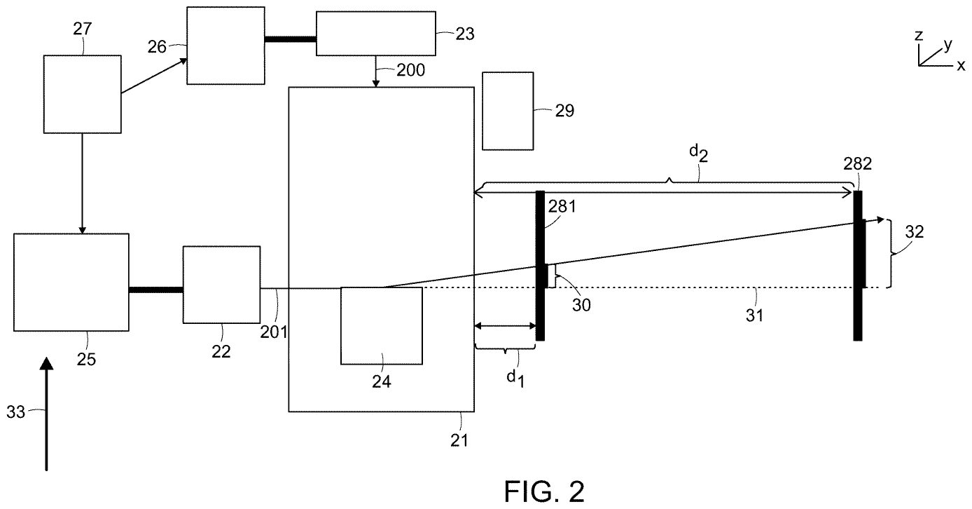

FIG. 2 depicts a top-view of a schematic representation of an example of a volumetric 3D printing system of the present invention. In this schematic representation, light sheet deflection from refractive index change is not necessarily to scale and may be exaggerated to clearly show the effect.

The depicted example includes a volumetric 3D printer. The depicted printer includes a container 21 for including a volume of a photohardenable composition, light sheet optics 22 for directing a light sheet 201 to a selected location in the volume of the photohardenable composition, projection optics 23 for projecting a selected optical image 200 to the selected location in the volume to form one or more three-dimensional objects in a volume of the photohardenable composition (the depicted example includes one three-dimensional object 24). Printing includes exposure of a series of selected locations in the volume to a light sheet and a series of selected projected optical images using a selected set of printing settings. In the depicted example, the 3D printer also includes a light sheet generator 25 in optical communication with the light sheet optics and a projector 26 in optical communication with the projection optics 23.

The depicted system also includes a controller 27 for controlling the printer for printing the one or more three-dimensional objects using a set of selected printing settings. The depicted system also includes a detector for determining light sheet deflection which can be measured during printing or analyzed after printing, and can be measured all throughout the print process.

In the depicted example, the detector includes an imaging screen 28 for receiving an image of the light sheet deflection (LSD) 30 and an imaging unit 29 for recording the light sheet deflection. The screen 28 can be located at a given distance (d) from the side of the container through which the light sheet exits the container.

While the amount of light sheet deflection distance compared to the undeflected light sheet path 31 of the imaged light sheet deflection will vary with the given distance of the screen from the container, the angle of the light sheet deflection in the resin be consistent without regard to the physical dimensions of the set-up for determining the distance of the deflection.

FIG. 2 shows light sheet deflection distance 30 for the screen at screen location 281, at a distance of d₁ from the side of the container through which the light sheet exits the volume. FIG. 2 also shows light sheet deflection 32 for the screen at screen location 282 when positioned at a distance of d₂ from the side of the container through which the light sheet exits the volume. The length of the light sheet deflection distance image 30 for the screen at screen location 281 is different than the light sheet deflection distance image 32 for screen at screen location 282. If length of the light sheet deflection image is to be used in correlating light sheet deflection distance and preliminary printing settings, the location of the screen should be constant.

To avoid such variations or inconsistencies based on the set-up, light sheet deflection distance can alternatively and preferably be represented by the deflection angle of the light sheet in the resin.

The light sheet deflection image can be used to calculate a light sheet deflection distance value corresponding to the deflected angle θ (in degrees) of the light sheet in the printing resin using the following equation:

$$θ = arcsin ( \frac{{n}_{1}}{{n}_{2}} * sin ( arctan ( \frac{d}{L} ) )$$

wherein:
L (mm)=distance from the container side through which the light sheet exits to the screen
n₁=refractive index of air=1
n₂=refractive index of the printing resin
d (mm)=the deflected distance on the screen (measured from the screen grid).

Defining light sheet deflection distance by the deflected angle θ (in degrees) of the light sheet in the printing resin is preferred since the deflected angle value is not affected by the physical set up of the detector, with the deflected angle value being the same regardless of the distance of the detector from the light sheet exit side of the container during measurement.

A suitable detector comprises a detector or vision system for capturing and characterizing deflection of a light sheet after it has passed through the resin during printing a three-dimensional object in a volume of a photohardenable composition included in a volumetric 3D printer. A detector system can include one or more integrated or separate components.

The light sheet can either impinge directly on the surface of a detector such as a charge coupled device sensor, or it can impinge on a screen, where the profile of the light sheet on the screen is then imaged by a detector such as a camera.

Measurement of the light sheet profile after traversing the resin during printing yields information about the curing speed of the resin because the curing process produces densification and temperature change, both of which serve to modify the refractive index of the resin. The modification in refractive index of resin locally around a curing part causes a bending of the light sheet light that transits near that part and leads to a characteristic deflection in the light sheet profile. The more curing occurring during the print, the larger the light sheet deflection.

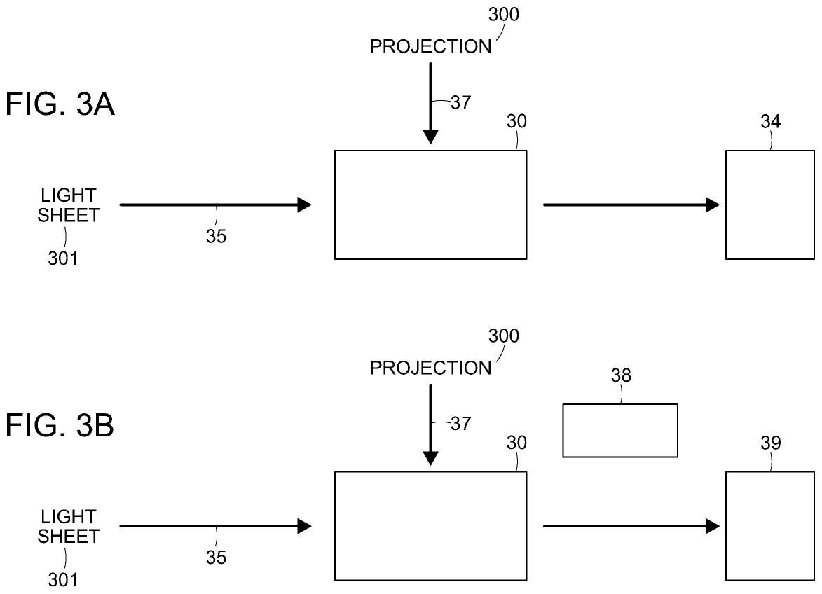

Two possible, non-limiting orientations for measuring the profile of a deflected light are depicted below in FIGS. 3A and 3B.

FIG. 3A depicts an example of a system including a light sheet 301 directed along a light sheet axis and a projected optical image 300 (labeled in the figure as a “projection”) directed along its projection axis 37 into a container 30 that includes a photohardenable composition. The set up also includes a single component detector 34, e.g., a charge coupled device (CCD) or a CMOS sensor including a surface onto which an image of the light sheet at a given selected location is imaged. See FIG. 3A.

Another example of a system, as depicted in FIG. 3B, includes a detector including a screen 39 for receiving an image of the deflected light sheet and an imaging device 38 that is directed to view the deflected light sheet on the screen (e.g., but not limited to, a camera, a video recorder, and the like) for recording the light sheet profile. Such systems can preferably further include software for analyzing and calculating a light sheet deflection value from the captured light sheet profile.

While printing the preliminary three-dimensional object in the volume of the photohardenable resin, a detector is preferably positioned at a given location relative to the location of the container including the photohardenable resin in which the preliminary printing is occurring, for capturing light sheet deflection data, e.g., an image of the light sheet deflection at a certain distance from the side of the container through which the light sheet exits the container at a selected location. The image data can then be mathematically analyzed to measure various parameters of the light sheet deflection as discussed above.

During the printing, data relating to the maximum displacement of the light sheet by the bending of light by refractive index changes in the vicinity of the printing part is collected. This displacement (also referred to herein as light sheet deflection) can be used to determine, for example, if the photohardenable composition is curing more or less than the usual behavior of the fresh photohardenable composition. Depending on how much more or less the light is deflected compared to known good print settings from previous experimentation on fresh well-behaved resin, the exposure setting can be adjusted to achieve similar amount of polymerization to the photohardenable composition.

Optionally, a second preliminary three-dimensional object can be printed with the modified set of print settings to confirm the modified printing settings are acceptable for achieving a printed part with the desired characteristics (e.g., resolution, dimensions, surface properties, geometry, and the like), or to identify the possibility that further modification of the printing settings may be desirable.

In accordance with another aspect of the present invention, there is provided a system for monitoring the profile of a light sheet passing through a volume of a photohardenable composition, the system comprising:
a container for holding the volume of the photohardenable composition having a light sheet entry side and an opposite light sheet exit side, wherein the container is oriented for the light sheet to pass through the entry of the container, preferably at an angle of 90 degrees,
a light blocking member coextensive with, and proximate to, the exit side of the container, wherein the light blocking member is parallel to the light sheet exit side of the container and includes an aperture positioned for passage of the light sheet exiting the container therethrough, the aperture being sized to allow passage of the light sheet with maximal distortion arising from passage of the light sheet through the photohardenable composition and to minimize passage of back-reflected light sheet into the container through the aperture,
a screen spaced from the blocking member and oriented parallel thereto, the screen being in path of the light sheet passing through the aperture,
a lens positioned in the path of the light sheet exiting the container between the light blocking member and the screen, wherein the lens is slightly tilted to prevent or minimize light sheet back-reflection from passing back through the aperture, and
a camera for capturing the profile of the light sheet on the screen.

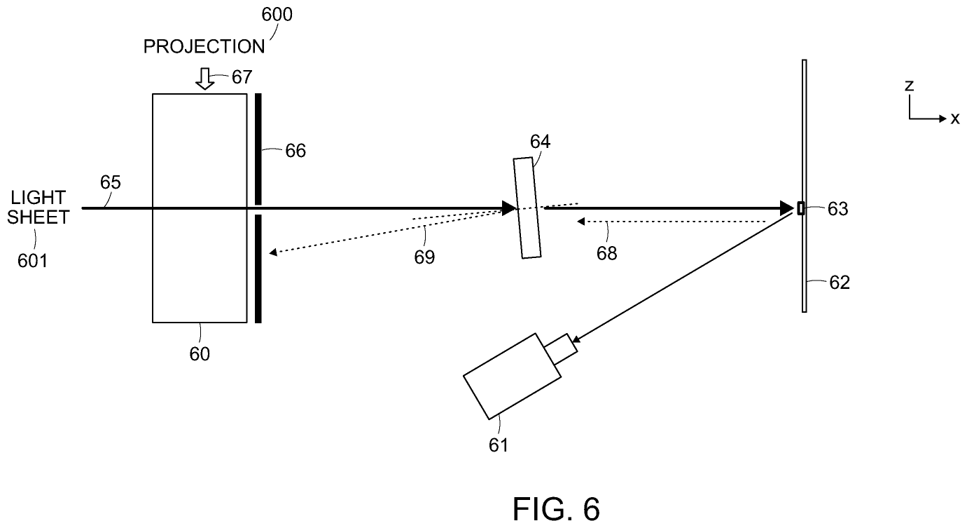

FIG. 6. depicts a top view of a schematic representation of an example of system including light sheet profile monitoring optics system for measuring and analyzing the profile of a deflected light sheet during printing.

FIG. 6 depicts an example of an embodiment of a system and method in accordance with the present invention that includes a light sheet 601 directed along a light sheet axis 65 and a projected optical image 300 (labeled in the figure as a “projection”) directed along its projection axis 67 into a container 60 that includes a photohardenable composition. The depicted system includes a detector including a screen 63 and an imaging device 61. (The screen may or may not be titled.) The depicted system also includes an aperture 66 positioned at the side of the container 60 through which the light sheet exits the container and an angled or tilted lens 64 positioned in the path between the aperture 66 and the screen 63. The inclusion of the aperture and the tilted lens are used to block or reduce the amount of, and preferably prevent, light sheet light back reflected from the screen from reentering the container. Back-reflected light that reenters the container can negatively affect the accuracy of parts being printed.

The aperture is preferably large enough to allow maximally distorted light sheet to fully pass through the aperture while also blocking some amount of back reflected light from reentering the container through the aperture.

The light sheet that passes through the lens is imaged onto a screen as an image 63 (e.g., an image of the profile of light sheet deflection) that may be viewed by a camera for characterization of the profile of a deflected light sheet.

In accordance with another aspect of the present invention, there is provided a system for monitoring the profile of a light sheet passing through a volume of a photohardenable composition, the system comprising:
a container for holding the volume of the photohardenable composition having a light sheet entry side and an opposite light sheet exit side, wherein the container is oriented for the light sheet to pass through the light sheet entry side of the container, preferably at an angle of 90 degrees,
a beam splitter in the path of the light sheet exiting the exit side of the container, the beam splitter being spaced from the light sheet exit side of the container and being of adequate size to facilitate reflection of a maximally distorted light sheet,
a beam dump spaced from the light sheet exit side of the container and in the light path of light transmitted by the beam splitter,
a screen spaced from and parallel to the path of the light sheet exiting the exit side of the container and positioned to be in the path of light reflected by the beam splitter, and
a camera for capturing the profile of the light sheet on the screen.

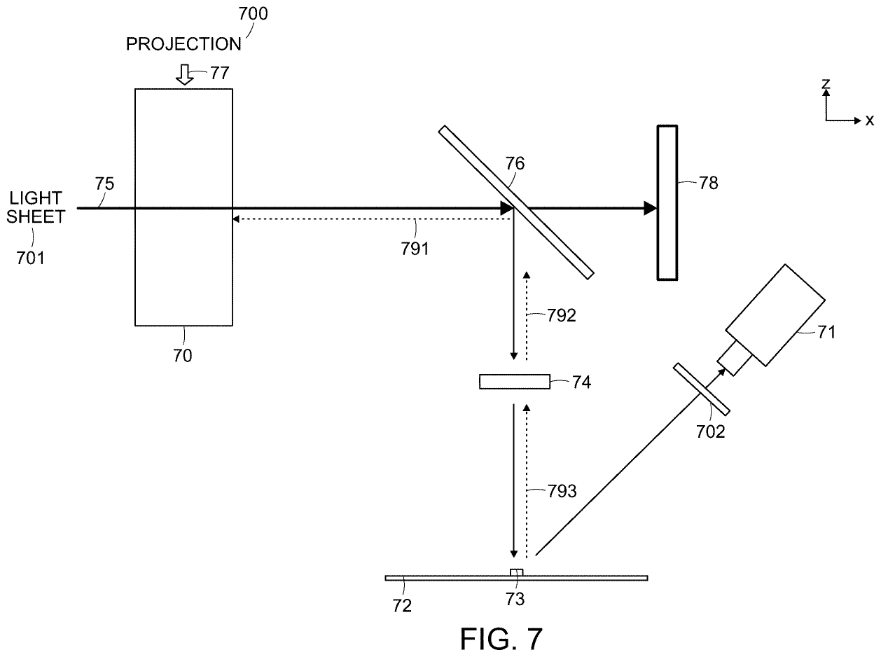

FIG. 7 depicts a top view of a schematic representation of an example of an embodiment of the present invention.

In the depicted system a light sheet 701 is directed along a light sheet axis 75 and a projected optical image 700 (labeled in the figure as a “projection”) directed along its projection axis 77 into a container 70 that includes a photohardenable composition to intersect with the light sheet. The depicted system includes a detector including a screen 72 and an imaging device 71. (The screen may or may not be tilted.) In the depicted system, a beam dump 78 is spaced from and positioned opposite the side of the container through which the light sheet exits the container and a glass slide or a beam splitter positioned between the light sheet exit side of the container and beam dump. The glass slide or beam splitter preferably has a Reflection/Transmission ratio (R/T) in which T>R. Examples of desirable ratios include 25/75 or 10/90. Other R/T ratios may also be used. The glass slide or beamsplitter is preferably large enough to reflect a maximally distorted light sheet. The screen 72 is positioned to receive the portion of the exiting light sheet that is reflected by the glass slide or beam splitter. An optional lens 74 is positioned between the glass slide or beam splitter 76 and the screen 72. The optional lens, preferably a cylinder lens, most preferably with curvature in the y-direction) can be included to reduce the spatial extent of the light sheet profile 73 so that it fits on the screen.

Possible occurrences of back reflection 791, 792, and 793 are identified.

In this example, reflection off the back surface of the beam splitter could cause a ghost image on the screen, This may be addressed by a commercial beamsplitter including a wedge (e.g., a 30 arcmin Wedge on Round optics) to separate the ghost image a bit more.

The light sheet that passes through the lens is imaged onto a screen that may be viewed by a camera 71 for characterization of the profile of a deflected light sheet. The camera may include a fixed or variable lens). A filter 702 is optionally positioned between the camera and the screen.

In the depicted example a beam splitter with T>R transmits the majority of the light sheet, after it exits the container, which is then transmitted to a beam dump, and the reflected light is used to generate the light sheet profile on the screen before being viewed by a camera. Optional use of a filter, e.g., short pass, long pass, or band pass filter, may help the camera obtain better signal to noise ratio. Optional inclusion of an optical element such a lens, between the beamsplitter and screen may make the light sheet profile a more convenient size for measurement.

In accordance with another aspect of the present invention, there is provided a system for monitoring the profile of a light sheet passing through a volume of a photohardenable composition, the system comprising:
a container for holding the volume of the photohardenable composition having a light sheet entry side and an opposite light sheet exit side, wherein the container is oriented for the light sheet to pass through the light sheet entry side of the container, preferably at an angle of 90 degrees,
a screen spaced from the light sheet exit side of the container and oriented parallel thereto,
a beam splitter located between the light sheet exit side of the container and the screen, the beam splitter being of and being of adequate size to facilitate reflection of a maximally distorted light sheet,
a beam dump in the path of light sheet light reflected by the beam splitter, the beam dump being spaced from the beam splitter, and
a camera for capturing the profile of the light sheet on the screen.

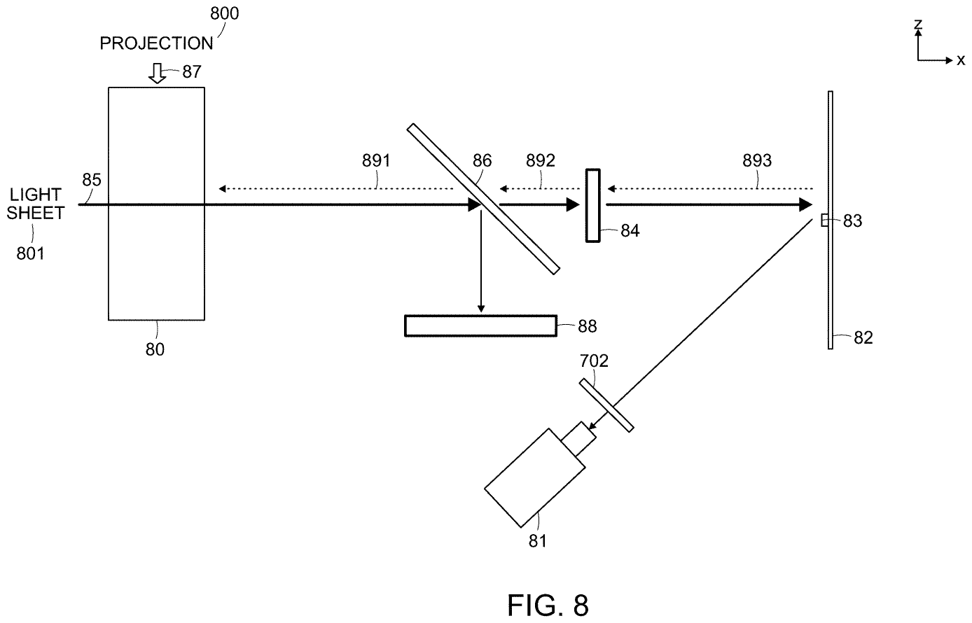

FIG. 8 depicts a top view of a schematic representation of an example of an embodiment of the present invention. In the depicted example a light sheet 801 is directed along a light sheet axis 85 and a projected optical image 800 (labeled in the figure as a “projection”) directed along its projection axis 87 into a container 80 that includes a photohardenable composition to intersect with the light sheet. The depicted system includes a detector including a screen 82 and an imaging device 81. (The screen may or may not be tilted.) In this depicted example, a beam splitter 86 is included in the path of the exiting light sheet between the container 80 and the screen 82. A beam dump 88 is also included and positioned to receive the reflected portion of the light sheet after exiting the container. The beam splitter preferably reflects the majority of the light sheet after it has transmitted the resin into a beam dump 88. The transmitted portion of the light sheet is imaged onto the screen 82 and the profile of the light sheet 83 is measured by a camera 81. The camera may include a fixed or variable lens). A filter 702 is optionally positioned between the camera and the screen.

An optional lens 84 is shown positioned between the beam splitter 86 and the screen 82. The optional lens, preferably a cylinder lens, most preferably with curvature in the y-direction) is shown included to reduce the spatial extent of the light sheet profile 83 so that it fits on the screen. A filter, e.g., short pass, long pass, or band pass filter,,, can be positioned between the camera and the screen for helping the camera obtain a better signal to noise ratio. Optional inclusion of an optical element such a lens, between the beamsplitter and screen may make the light sheet profile a more convenient size for measurement.

Possible occurrences of back reflection 891, 892, and 893 are identified.

As mentioned elsewhere herein, a three-dimensional object that is printed to determine a modified set of printing settings can optionally be a small calibration part to reduce the amount of printing resin used and printing time involved in determining the set of printing settings to be used to print the one or more actual desired three-dimensional objects. Such protocol can be repeated one or more times until a set of optimal printing settings is determined. Optionally a calibration part can be printed at a first location in the volume, and a desired part can be printed at a second location using the modified printing settings determined based on light sheet deflection determined from printing the calibration part with the preliminary printing settings. After printing, the calibration cubes can be discarded while the part of interested is retrieved. Optionally, the calibration part can be removed before the desired three-dimensional object is printed in the volume of the printing resin.

A more detailed description of an example of a detector including an imaging device and screen is provided below in the Examples.

Methods in accordance with the present invention can preferably be carried out using a volumetric 3D printing system described herein.

### Examples

The following are provided as examples and not limitations, wherein a number of modifications of the exemplified compositions and processes are contemplated and within the scope of the present invention.

### Preparation of Printing Resin Used to Print the Three-Dimensional Objects a, B, C.

Resin was prepared as follows. To a Flacktek speedmixing container was added a urethane dimethacrylate oligomer Genomer 4247 (350 g), 1,6-hexanediol dimethacrylate (15.4 g), a 1.00 mg/g solution of dual-wavelength photoswitchable photoinitiator AE32 in 1,6-hexanediol dimethacrylate (7.70 g), and methyldiethanolamine (3.85 g). The contents were speedmixed for 5 minutes at 1200 rpm. To the same container was then added Rheobyk-430 (7.70 g), then the contents were speedmixed again for 5 minutes at 1200 rpm. Resin was transferred to 1 centimeter path length plastic cuvettes and centrifuged at 2000 RPM for two minutes to remove bubbles, and then incubated in an oven at 50 degrees Celsius until temperature stabilized at 50 degrees in the resin prior to printing.

Dual-wavelength photoswitchable photoinitiator AE32 was prepared substantially as described in the Example section of International Application No. PCT/US2023/022172 of Quadratic 3D, Inc. filed May 13, 2023, for the photoswitchable photoinitiator having the same designation.

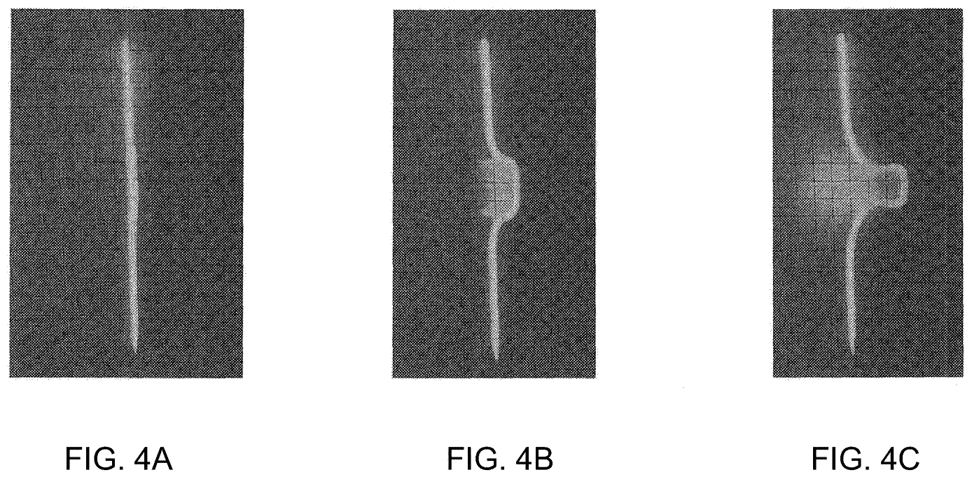

FIGS. 4A, 4B, and 4C depict image data from separate printings of three-dimensional objects A, B, and C. Each of samples A, B, and C was printed using a set of preliminary printing settings that was substantially the same except for the printing exposure time. Each of printed parts A, B, and C was a 7 mm×7 mm×7 mm cube. The printing resin for each print was prepared substantially as set forth above and was freshly prepared.

The preliminary set of printing settings, except for printing exposure time, used to print parts A, B, and C were substantially the same and are summarized below:

Projector light-532 nm, approximately 1.6 Watt per centimeter squared. Light sheet-405 nm light, approximately 200 microns wide, irradiance of approximately 0.7 Watt per centimeter squared. Slice thickness was 28 microns. Resin temperature for printing was 50 degrees Celsius. Exposure time per slice was varied between the three prints and an image of the light sheet deflection during the last second of printing is shared in FIGS. 4A, B and C.

FIGS. 4A-4C show the image data for the printing of samples A, B, and C, respectively, against a 5 mm×5 mm grid.

In the three separate prints, the printing exposure time was increased from FIG. 4A to FIG. 4B to FIG. 4C. Correspondingly, a smaller, medium, or larger amount of light sheet deflection was observed. In previous experiments, good quality prints were found to result from printing conditions resulting in a light sheet deflection of 5 millimeters compared to the undeflected path of the light sheet light.

The exposure time for the example represented by FIG. 4A was 0.12 seconds per slice. The results for FIG. 4A indicate an insufficient amount of cure using the set of printing settings including the exposure time used as evidenced by the minimal amount of light sheet deflection of around 1 millimeter compared to known good print settings which typically yield light sheet deflection around 5 millimeters. The exposure time for the example represented by FIG. 4B was 0.18 seconds per slice. The results for FIG. 4B indicate an optimal amount of cure using the set of printing settings including the exposure time used as evidenced by light sheet deflection of around 5 millimeters which had previously been determined to correspond to good quality printing results. The exposure time for the example represented by FIG. 4C was 0.26 seconds. The results for FIG. 4C indicate an excessive amount of cure resulting from this exposure time as evidenced by the much larger light sheet deflection, around 15 millimeters, than known good print settings which typically yield a light sheet deflection around 5 millimeters.

The detector used to generate the data for samples A, B, and C included an imaging device positioned between the printing container and a screen located 300 millimeters from the side of the container through which the light sheet exited the container. The imaging device used was a Logitech C920X webcam. The screen that was used was a 5 mm×5 mm paper grid mounted flush on an anodized aluminum sheet perpendicular to the path of the light sheet light that has transmitted the resin and secured to the optical table supporting the volumetric 3D printing system. The imaging device was placed a given distance, here 180 mm, from the screen, between the light sheet exit face of the container and the screen, facing the screen. A long pass 460 nm filter was added to the Logitech C920X webcam to reduce light sheet brightness while allowing the imaging device to view the grid pattern on which the light sheet deflection line is projected. As mentioned above, the screen is positioned a given distance, here 300 mm, from the exit face of the container. The “Logitech capture” setting for the Logitech C920X webcam was used to collect the videos.

Detailed light sheet deflection information can be determined using the data obtained from the collected videos.

As discussed above, it can be preferred to characterize light sheet deflection in terms of the deflected angle θ (in degrees) of the light sheet in the printing resin using the following equation:

$$θ = arcsin ( \frac{{n}_{1}}{{n}_{2}} * sin ( arctan ( \frac{d}{L} ) )$$

wherein:
L (mm)=distance from the container side through which the light sheet exits to the screen
n₁=refractive index of air=1
n₂=refractive index of the printing resin
d (mm)=the deflected distance on the screen (measured from the screen grid).

Defining light sheet deflection by the deflected angle θ (in degrees) of the light sheet in the printing resin is preferred since the angle value is not affected by the physical set up of the detector with the angle value being the same regardless of the distance of the screen from the container during measurement. If light sheet deflection is not defined by the deflected angle of the light sheet in the printing resin, the same physical set-up should be used when comparing deflection from different print runs for consistency.

Correlation of printing settings and the light sheet deflection enables determining a modified set of printing settings for subsequent printing in the same printing resin, a freshly made printing resin having substantially the same composition, a reuse of the same printing resin, or printing of a resin where the temperature of the resin or the brightness of the projector is different from the usual printing settings but a similar printing result to known good print settings is still desired.

The calculated light sheet deflection values for the samples represented by FIGS. 4A, 4B, and 4C, respectively, are 1 mm, 5 mm, and 15 mm.

After retrieving the objects from the printing resin, the preliminary printing settings used for FIG. 4B were determined to provide the best relative print quality of the three. Print settings used in FIG. 4A yielded a soft part that was susceptible to damage on handling, print settings from FIG. 4B yielded a handleable, well-shaped cube, and settings from FIG. 4C yielded a very firm cube but with excessive cure distorting its shape.

In a subsequent printing of one or more objects in the same printing resin, to attain print quality similar to that demonstrated in FIG. 4B, it would be desirable to use a set of printing settings similar to those used for the object of FIG. 4B.

If a situation such as shown in FIG. 4A is obtained, in a subsequent printing of one or more objects in the same printing resin, to increase light sheet deflection, the preliminary printing settings used to print the object of FIG. 4A can be modified, for example, to include a higher printing exposure time, whereas if light sheet deflection is very large, such as shown in FIG. 4C, the preliminary printing settings can be modified, for example, to include a lower printing exposure time.

Optionally, to adjust light sheet deflection, changes can be made to a printing setting other than printing exposure after correlating the light sheet deflection to the particular printing setting selected for adjustment.

Preferably, data is collected to assess cure rates and calibrate the printer. Light sheet deflection can be measured for a given set of preliminary printing settings used to print the calibration part. Deflection can also be used to simply validate that existing print settings are yielding the same amount of deflection they are expected to yield.

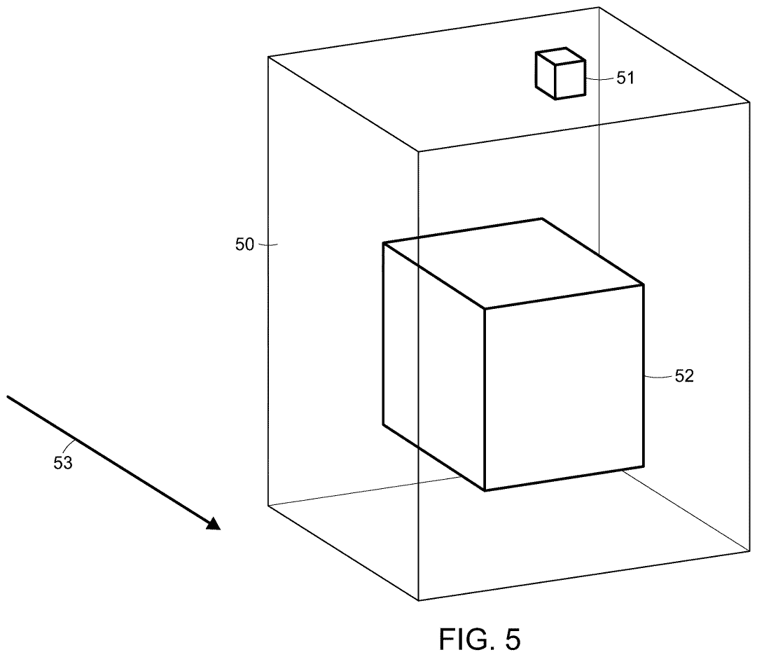

One particularly advantageous way to take advantage of this information is to construct a build volume with a small test part in advance of the desired final printed object. As shown in FIG. 5, optionally a small calibration part 51can be printed at a first location in the volume of the photohardenable composition 50 using a set of preliminary printing settings and light sheet deflection can be measured therefor and correlated to the set of preliminary printing settings to determine a modified set of printing settings for use in printing the intended part 52. See for example FIG. 5 which depicts a small calibration part 51 printed at a first location in the volume 50 to determine light sheet deflection for printing the calibration part in the resin using a set of preliminary printing settings, following which a correlation the light sheet deflection and set of preliminary printing settings is made, and a set of printing settings is determined and used to print a separate three-dimensional object 52 in the same resin. The direction of print progression is also indicated by an arrow 53.

For example, the measured deflection for the calibration part can be compared to the deflection achieved in a resin where the print settings are known to produce acceptable printing results. The print settings can then be varied based on this information. For example, if the calibration object produced less light sheet deflection than the calibration object during a reference print with acceptable print quality, for the remainder of the print where the object of interest is printed, the laser power and/or exposure setting can be increased to increase the amount of cure. Optionally, the process can occur iteratively, where a first calibration part is printed, then settings are adjusted, a second calibration part is printed, etc. until acceptable agreement is found between the current settings and the light sheet deflection in a known print setting producing acceptable print quality, at which point these settings are applied to the printing of the part of interest.

Optionally, the calibration part can be removed before the desired three-dimensional object is printed. Or, optionally, after printing, the calibration object can be discarded while the shape of interest is retrieved.

The methods and systems described herein facilitate a direct measurement of the printing activity of the resin, which can be used to fine-tune the correct printing settings.

Embodiments of inventions described herein include the following:
Embodiment 1. A method comprising:
(a) printing a three-dimensional object in a volume of a photohardenable composition, wherein printing the three-dimensional object includes exposure of a series of selected locations in the volume to a light sheet and a selected projected optical image using a set of preliminary printing settings; and
(b) determining deflection of a light sheet profile during printing the three-dimensional object using the set of preliminary printing settings.
Embodiment 2. A method comprising:
(a) printing a three-dimensional object in a volume of a photohardenable composition, wherein printing the three-dimensional object includes sequential exposure of a series of selected locations in the volume to a light sheet and a selected projected optical image using a set of preliminary printing settings;
(b) determining a light sheet deflection profile during printing the three-dimensional object using the set of preliminary printing settings;
(c) correlating the determined light sheet deflection profile to one or more of the preliminary printing settings to determine one or more modifications to the preliminary printing settings for use in subsequently printing one or more three-dimensional objects in the volume of the photohardenable composition.
Embodiment 3. A method for use in determining settings for printing a three-dimensional object in a volume of a photohardenable composition, the method comprising:
(a) printing a calibration part in a volume of the photohardenable composition including exposure of a series of selected locations in the volume to a light sheet and a series of selected projected optical images using a set of preliminary printing settings;
(b) determining a light sheet deflection profile during printing the calibration part with the preliminary printing settings;
(c) correlating light sheet deflection profile to the preliminary printing settings; and
(d) modifying one or more of the preliminary printing settings for use in printing one or more three-dimensional objects in the photohardenable composition to adjust light sheet deflection during printing the one or more three-dimensional objects.
Embodiment 4. A method of printing one or more three-dimensional objects in a volume of a photohardenable composition, the method comprising:
(a) determining one or more modifications to a set of preliminary printing settings used to print a calibration part in the photohardenable composition; and
(b) printing one or more three-dimensional objects in the photohardenable composition including exposure of a series of selected locations in the volume to a light sheet and a series of projected optical images using the modified preliminary printing settings.
Embodiment 5. The method of Embodiment 4 wherein step (a) includes determining a light sheet deflection profile during printing the calibration part in the volume of the photohardenable composition using the preliminary set of printing settings, correlating the determined light sheet deflection profile to the set of preliminary printing settings, and adjusting one or more printing settings to create modified preliminary printing settings.
Embodiment 6. The method of Embodiment 5 wherein the modified preliminary printing settings are used to adjust light sheet deflection during printing one or more three-dimensional objects in the photohardenable composition.
Embodiment 7. A method of printing one or more three-dimensional objects in a volume of a photohardenable composition, the method comprising:
(a) determining one or more modifications to a set of preliminary printing settings used to print a calibration part in the photohardenable composition including exposure of a series of selected locations in the volume to a light sheet and a series of selected projected optical images using the set of preliminary printing settings wherein the modifications are correlated to variation of a light sheet profile (e.g., light sheet deflection profile) imaged during printing; and
(b) printing one or more three-dimensional objects in the photohardenable composition including exposure of a series of selected locations in the volume to a light sheet and a series of projected optical images using the modified preliminary printing settings.
Embodiment 8. The method of Embodiment 7 wherein step (a) includes determining a light sheet deflection profile during printing the calibration part in the volume of the photohardenable composition using the preliminary set of printing settings, correlating the determined light sheet deflection profile to the set of preliminary printing settings, and adjusting one or more printing settings to create modified preliminary printing settings.
Embodiment 9. A method of printing one or more three-dimensional objects in a volume of a photohardenable composition, the method comprising:
(a) printing a three-dimensional object in the photohardenable composition including exposure of a series of selected locations in the volume to a light sheet and a series of selected projected optical images using the set of preliminary printing settings;
(b) monitoring variation of a profile of the light sheet during printing;
(c) correlating the variation of the profile of the light sheet to the set of preliminary printing settings to determine one or more modifications to the set of preliminary printing setting, and
(d) printing one or more three-dimensional objects in the photohardenable composition including exposure of a series of selected locations in the volume to a light sheet and a series of projected optical images using the modified preliminary printing settings.
Embodiment 10. A method of printing one or more three-dimensional objects in a volume of a photohardenable composition, the method comprising:
(a) printing a calibration part in a volume of the photohardenable composition, wherein printing comprises intersecting a light sheet and one of a series of projected optical images at a series of selected locations in the volume using a set of preliminary printing settings;
(b) monitoring variation of the profile of the light sheet during printing,
(c) correlating the variation of the profile of light sheet to the set of preliminary printing settings to determine any one or more modifications to the set of preliminary printing settings used to print a calibration part; and
(d) printing one or more three-dimensional objects in the photohardenable composition including exposure of a series of selected locations in the volume to a light sheet and a series of projected optical images using the modified preliminary printing settings.
Embodiment 11. The method of Embodiment 2 or 3 wherein one or more of the preliminary printing settings are modified to adjust the determined light sheet deflection profile during subsequent printing of the one or more three-dimensional objects in the volume.
Embodiment 12. The method of any one of Embodiments 8, 9, and 10 wherein one or more of the modifications included in the modified set of preliminary printing settings are selected to adjust light sheet deflection profile within a selected range during printing of the one or more three-dimensional objects in the volume.
Embodiment 13. The method of any one of Embodiments 1 through 10 wherein printing settings include one or more of printing exposure time for a given selected location, power level of a projector included in generating the selected projected optical image for the given selected location, power level of a light sheet generator included in generating the light sheet for the given selected location, thickness of the light sheet for the given selected location.
Embodiment 14. The method of any one of Embodiments 3, 4, 7, and 10 wherein the projected optical image corresponds to a cross-sectional slice of the calibration part.
Embodiment 15. The method of Embodiment 1, 2, 4 or 9 wherein the projected optical image corresponds to a cross-sectional slice of the three-dimensional object.
Embodiment 16. The method of Embodiment 2 further comprising subsequently printing the one or more three-dimensional objects in the volume of the photohardenable composition using the modified preliminary printing settings in which one or more of the preliminary printing settings have been modified to adjust light sheet deflection profile for the subsequent printing of the one or more three dimensional objects.
Embodiment 17. The method of Embodiment 3 further comprising subsequently printing the one or more three-dimensional objects in the volume of the photohardenable composition using the modified preliminary printing settings in which one or more of the preliminary printing settings have been modified to adjust light sheet deflection profile for the subsequent printing of the one or more three dimensional objects.
Embodiment 18. The method of Embodiment 16 or 17 wherein light sheet deflection during the subsequent printing of the one or more three-dimensional objects in the photohardenable composition using the modified preliminary printing settings is re-determined before reusing the photohardenable composition to print one or more additional three-dimensional objects.
Embodiment 19. The method of Embodiment 9 or 10 wherein variation of the light sheet profile during the printing of the one or more three-dimensional objects in the photohardenable composition using the modified preliminary printing settings is re-determined before reusing the photohardenable composition to print one or more additional three-dimensional objects.
Embodiment 20. The method of Embodiment 18 wherein deflection of the light sheet during the subsequent printing of the one or more three-dimensional objects in the volume is determined and correlated to the modified set of printing settings to determine any further modifications of the modified set of printing settings before reusing the photohardenable composition to print one or more additional three-dimensional objects.
Embodiment 21. The method of any one of Embodiments 4, 9, and 10 wherein variation of the light sheet profile during a subsequent printing of the one or more three-dimensional objects in the volume is determined and correlated to the modified set of printing settings to determine any further modifications of the modified set of printing settings before reusing the photohardenable composition to print one or more additional three-dimensional objects.
Embodiment 22. The method of any one of Embodiments 3, 7, and 10 further comprising removing the calibration part printed with use of the set of preliminary printing settings from the volume before subsequent printing one or more three-dimensional objects in the volume.
Embodiment 23. The method of Embodiment 5 or 9 further comprising removing the three-dimensional object printed with use of the set of preliminary printing settings from the volume before printing the one or more three-dimensional objects in the volume.
Embodiment 24. The method of Embodiment 16 further comprising repeating steps (b) and (c) for the one or more three-dimensional objects subsequently printed with the modified preliminary printing settings to determine light sheet deflection for the one or more subsequently printed part to determine any further changes to one or more of the modified printing settings before a next print.
Embodiment 25. The method of Embodiment 24 further comprising one or more successive subsequent prints wherein steps (b) and (c) are repeated for each successive subsequent print.
Embodiment 26. The method of Embodiment 24 wherein maintaining the light sheet deflection profile within a selected range for one or more reuses of the photohardenable composition to print three-dimensional objects is used to assess run-to-run printing consistency for the three-dimensional objects printed in the one or more reuses of the photohardenable composition.
Embodiment 27. The method of Embodiment 25 further including maintaining light sheet deflection profile within a selected range for a reuse of the photohardenable composition to print three-dimensional objects.
Embodiment 28. The method of Embodiment 17 further comprising repeating steps (b)-(d) for the one or more three-dimensional objects subsequently printed with the modified preliminary printing settings to determine light sheet deflection for the one or more subsequently printed part to determine any further changes to one or more of the modified printing settings before a next print.
Embodiment 29. The method of Embodiment 28 further comprising one or more successive subsequent prints wherein steps (b)-(d) are repeated for each successive subsequent print.
Embodiment 30. The method of Embodiment 29 wherein maintaining the light sheet deflection profile within a selected range for one or more reuses of the photohardenable composition to print three-dimensional objects is used to assess run-to-run printing consistency for the three-dimensional objects printed in the one or more reuses of the photohardenable composition.
Embodiment 31. The method of Embodiment 30 further including maintaining light sheet deflection profile within a selected range for a reuse of the photohardenable composition to print three-dimensional objects.
Embodiment 32. The method of Embodiment 31 further comprising one or more successive subsequent prints wherein steps (b)-(d) are repeated for each successive subsequent print.
Embodiment 33. The method of Embodiment 31 wherein maintaining the light sheet deflection profile within a selected range for one or more reuses of the photohardenable composition to print three-dimensional objects is used to assess run-to-run printing consistency for the three-dimensional objects printed in the one or more reuses of the photohardenable composition.
Embodiment 34. The method of Embodiment 7 further comprising repeating step (a) for the one or more three-dimensional objects printed with the modified preliminary printing settings to determine one or more further modifications of the modified set of preliminary printing settings to determine any further changes to the modified set of preliminary printing settings before a next print.
Embodiment 35. The method of Embodiment 34 further comprising one or more successive subsequent prints wherein step (a) is repeated for each successive subsequent print.
Embodiment 36. The method of Embodiment 34 wherein maintaining the light sheet profile within a selected range of variation for one or more reuses of the photohardenable composition to print three-dimensional objects is used to assess run-to-run printing consistency for the three-dimensional objects printed in the one or more reuses of the photohardenable composition.
Embodiment 37. The method of Embodiment 34 further including maintaining the light sheet profile within a selected range of variation for a reuse of the photohardenable composition to print three-dimensional objects.
Embodiment 38. The method of Embodiment 9 or 10 further comprising repeating steps (b) and (c) for the one or more three-dimensional objects printed with the modified preliminary printing settings to determine one or more further modifications of the modified set of preliminary printing settings to determine any further changes to the modified set of preliminary printing settings before a next print.
Embodiment 39. The method of Embodiment 38 further comprising one or more successive subsequent prints wherein steps (b) and (c) are repeated for each successive subsequent print.
Embodiment 40. The method of Embodiment 38 wherein maintaining the light sheet profile within a selected range of variation for one or more reuses of the photohardenable composition to print three-dimensional objects is used to assess run-to-run printing consistency for the three-dimensional objects printed in the one or more reuses of the photohardenable composition.
Embodiment 41. The method of Embodiment 38 further including maintaining the light sheet profile within a selected range of variation for a reuse of the photohardenable composition to print three-dimensional objects.
Embodiment 42. The method of any one of Embodiments 4, 3, 7, and 9 further comprising removing the calibration part printed with use of the set of preliminary printing settings from the volume before printing the one or more three-dimensional objects in the volume.
Embodiment 43. The method of any one of Embodiments 1, 2, and 9 further comprising removing the three-dimensional object printed with use of the set of preliminary printing settings from the volume before printing the one or more three-dimensional objects in the volume.
Embodiment 44. The method of Embodiment 2 or 3 wherein the volume of the photohardenable composition is included in a three-dimensional volumetric printing system, and wherein the method further comprises:
generating modified printing settings for printing the one or more three-dimensional objects in the volume, wherein the modified printing settings include the preliminary printing settings including the one or more determined modifications for adjusting the light sheet deflection profile for use in printing one or more three-dimensional objects therewith; and
communicating the modified printing settings to the three-dimensional volumetric printing system.
Embodiment 45. The method of Embodiment 44 further comprising executing the modified printing settings by the three-dimensional volumetric printing system to print the one or more three-dimensional objects in the volume of the photohardenable composition.
Embodiment 46. The method of Embodiment 4 or 7 wherein the volume of the photohardenable composition is included in a three-dimensional volumetric printing system, and wherein the method further comprises:
generating modified printing settings for printing the one or more three-dimensional objects in the volume, wherein the modified printing settings include the preliminary printing settings including the one or more determined modifications which one or more of the preliminary printing settings has been modified; and
communicating the modified printing settings to the three-dimensional volumetric printing system.
Embodiment 47. The method of Embodiment 46 further comprising executing the modified printing settings by the three-dimensional volumetric printing system to print the one or more three-dimensional objects in the volume of the photohardenable composition.
Embodiment 48. The method of Embodiment 2 or 3 wherein the volume of the photohardenable composition is included in a three-dimensional volumetric printing system, and wherein the method further comprises:
generating modified printing settings for printing the one or more three-dimensional objects in the volume, wherein the modified printing settings include the preliminary printing settings including the one or more determined modifications for adjusting the light sheet deflection profile for use in printing one or more three-dimensional objects therewith; and
communicating the modified printing settings to the three-dimensional volumetric printing system.
Embodiment 49. The method of Embodiment 48 further comprising executing the modified printing settings by the three-dimensional volumetric printing system to print the one or more three-dimensional objects in the volume of the photohardenable composition.
Embodiment 50. The method of Embodiment 9 or 10 wherein the volume of the photohardenable composition is included in a three-dimensional volumetric printing system, and wherein the method further comprises:
generating modified printing settings for printing the one or more three-dimensional objects in the volume, wherein the modified printing settings include the preliminary printing settings including the one or more determined modifications for adjusting the light sheet profile for use in printing one or more three-dimensional objects therewith; and
communicating the modified printing settings to the three-dimensional volumetric printing system.
Embodiment 51. The method of Embodiment 50 further comprising executing the modified printing settings by the three-dimensional volumetric printing system to print the one or more three-dimensional objects in the volume of the photohardenable composition.
Embodiment 52. The method of Embodiment 34 wherein maintaining the light sheet deflection profile within a selected range of variation for different batches of the photohardenable composition is used to maintain run-to-run printing consistency for the three-dimensional objects printed with the photohardenable composition.
Embodiment 53. The method of Embodiment 34 wherein maintaining the light sheet profile within a selected range of variation for different batches of the photohardenable composition is used to maintain run-to-run printing consistency for the three-dimensional objects printed with the photohardenable composition.
Embodiment 54. A volumetric 3D printing system comprising:
(a) a volumetric 3D printer including a container for containing a volume of a photohardenable composition, light sheet optics configurable for directing a light sheet to a selected location in the volume of the photohardenable composition, projection optics configurable for projecting a selected optical image to the selected location in the volume to print a three-dimensional object in a volume of the photohardenable composition including sequential exposure of a series of selected locations in the volume to a light sheet and a series of projected optical images using a selected set of printing settings;
(b) a controller for controlling the printer for printing the one or more three-dimensional objects using the set of selected printing settings; and
(c) a detector for capturing a light sheet profile of the three-dimensional object being printed after exposure of the photohardenable composition to the light sheet and the projected optical image at the selected location.
Embodiment 55. The volumetric 3D printing system of Embodiment 54 wherein the detector includes a surface comprising a charge coupled device sensor onto which the light sheet profile is imaged.
Embodiment 56. The volumetric 3D printing system of Embodiment 54 wherein the detector includes an imaging screen for receiving an image of the light sheet profile and an imaging device for recording the light sheet profile.
Embodiment 57. A system for monitoring the profile of a light sheet passing through a volume of a photohardenable composition, the system comprising:
a container for holding the volume of the photohardenable composition having a light sheet entry side and an opposite light sheet exit side,
a light blocking member at least coextensive with, and proximate to, the exit side of the container, wherein the light blocking member is parallel to the light sheet exit side of the container and includes an aperture positioned for passage of the light sheet exiting the container therethrough, the aperture being sized to allow passage of the light sheet with maximal distortion arising from passage of the light sheet through the photohardenable composition and to minimize passage of back-reflected light sheet into the container through the aperture,
a screen spaced from the blocking member and oriented parallel thereto, the screen being in path of the light sheet passing through the aperture,
a lens positioned in the path of the light sheet exiting the container between the light blocking member and the screen, wherein the lens is slightly tilted to prevent or minimize light sheet back-reflection from passing back through the aperture, and
a camera for capturing the profile of the light sheet on the screen.
Embodiment 58. The system of Embodiment 57 wherein one or both major surfaces of the light blocking member are non-reflective.
Embodiment 59. A system for monitoring the profile of a light sheet passing through a volume of a photohardenable composition, the system comprising:
a container for holding the volume of the photohardenable composition having a light sheet entry side and an opposite light sheet exit side,
a beam splitter in the path of the light sheet exiting the exit side of the container, the beam splitter being spaced from the light sheet exit side of the container and being of adequate size to facilitate reflection of a maximally distorted light sheet,
a beam dump spaced from the light sheet exit side of the container and in the light path of light transmitted by the beam splitter,
a screen spaced from and parallel to the path of the light sheet exiting the exit side of the container and positioned to be in the path of light reflected by the beam splitter, and
a camera for capturing the profile of the light sheet on the screen.
Embodiment 60. The system of Embodiment 59 wherein the beam splitter has a split ratio of Reflection/Transmission (R/T) wherein R<T.
Embodiment 61. The system of Embodiment 59 wherein a glass slide is used in place of a beam splitter.
Embodiment 62. The system of Embodiment 59 further including a lens positioned between the beam splitter and the screen to reduce the spatial extent of the light sheet profile for reducing the size of the screen for capturing the light sheet profile.
Embodiment 63. A system for monitoring the profile of a light sheet passing through a volume of a photohardenable composition, the system comprising:
a container for holding the volume of the photohardenable composition having a light sheet entry side and an opposite light sheet exit side,
a screen spaced from the light sheet exit side of the container and oriented parallel thereto,
a beam splitter located between the light sheet exit side of the container and the screen, the beam splitter being of and being of adequate size to facilitate reflection of a maximally distorted light sheet,
a beam dump in the path of light sheet light reflected by the beam splitter, the beam dump being spaced from the beam splitter, and
a camera for capturing the profile of the light sheet on the screen.
Embodiment 64. The system of Embodiment 59 further including a lens positioned between the beam splitter and the screen to reduce the spatial extent of the light sheet profile for reducing the size of the screen for capturing the light sheet profile.
Embodiment 65. The system of Embodiment 63 wherein the beam splitter has a split ratio of Reflection/Transmission wherein R>T.
Embodiment 66. The system of any one of Embodiments 57, 59, and 63 wherein the camera has a variable focus lens.
Embodiment 67. The system of any one of Embodiments 57, 59, and 63 further including a filter between the camera and screen.
Embodiment 68. The system of any one of Embodiments 57, 59, and 63 wherein the screen is tilted.
Embodiment 69. The system of any one of Embodiments 57, 59, and 63 wherein the screen is not tilted.
Embodiment 70. The system of Embodiment 57 wherein the container is oriented for the light sheet to pass through the entry of the container at an angle of 90 degrees.
Embodiment 71. The system of Embodiment 59 wherein the container is oriented for the light sheet to pass through the light sheet entry side of the container at an angle of 90 degrees.
Embodiment 72. The system of Embodiment 63 wherein the container is oriented for the light sheet to pass through the light sheet entry side of the container, preferably at an angle of 90 degrees.
Embodiment 73. The method of any one of Embodiments 1, 2, 3, 4, 7, 9, and 10 wherein the photohardenable composition includes a photohardenable resin component and a photoinitiator.
Embodiment 74. The method of Embodiment 73 wherein the photoinitiator comprises a dual wavelength photoinitiator.
Embodiment 75. The method of Embodiment 73 wherein the dual wavelength photoinitiator comprises a photoswitchable photoinitiator.
Embodiment 76. The method of Embodiment 74 wherein the photohardenable composition further includes a coinitiator.
Embodiment 77. The method of Embodiment 75 wherein the photohardenable composition further includes a coinitiator.
Embodiment 78. The method of any one of Embodiments 1, 2, 3, 4, 7, 9, and 10 wherein the photohardenable composition demonstrates non-Newtonian rheological behavior.
Embodiment 79. The method of any one of Embodiments 1, 2, 3, 4, 7, 9, and 10 wherein the light sheet is generated with a first excitation light including a first wavelength with a first power density and first exposure energy and the projected optical image is generated with a second excitation light including a second wavelength with a second power density and second exposure energy.
Embodiment 80. The method of Embodiment 79 wherein the exposure energy for the first wavelength light is in a range from about 0.001 to about 1,000 mJ/cm².
Embodiment 81. The method of Embodiment 79 wherein the power density for the second wavelength light is in a range from about 0.01 to about 100,000 mJ/cm².
Embodiment 82. The method of any one of Embodiments 1, 2, 3, 4, 7, 9, and 10 wherein the light sheet is generated with a first excitation light including a first wavelength with a first power density and first exposure energy and the projected optical image is generated with a second excitation light including a second wavelength with a second power density and second exposure energy.
Embodiment 83. The method of Embodiment 81 wherein the power density for the first wavelength light is in a range from about 0.01 to about 100,000 W/cm².
Embodiment 84. The method of Embodiment 81 wherein the power density for the second wavelength light is in a range from about 0.01 to about 100,000 mJ/cm².
Embodiment 85. The volumetric 3D printing system of any one of Embodiments 57, 59, and 63 wherein the photohardenable composition comprises a photohardenable resin component and a photoinitiator.
Embodiment 86. The volumetric 3D printing system of Embodiment 85 wherein the photoinitiator comprises a dual wavelength photoinitiator.
Embodiment 87. The volumetric 3D printing system of Embodiment 85 wherein the photoinitiator comprises a photoswitchable photoinitiator.
Embodiment 88. The volumetric 3D printing system of claim 86 wherein the photohardenable composition further includes a coinitiator.
Embodiment 89. The volumetric 3D printing system of claim 87 wherein the photohardenable composition further includes a coinitiator.
Embodiment 90. The volumetric 3D printing system of any one of claims 57, 59, and 63 wherein the photohardenable composition demonstrates non-Newtonian rheological behavior.

In methods and system described herein, the volume of the photohardenable composition may be irradiated with one or more one or more excitation lights to at least partially harden, polymerize, and/or cross-link photohardenable composition to at least partially form the one or more 3D objects in the volume of the photohardenable composition. Preferably at least one of the excitation lights is directed into the volume as a light sheet.

In methods and system described herein, selection of excitation lights and wavelengths is preferably made taking into account the photohardening mechanism of a photohardenable composition. For example, for a photohardenable composition that is photohardenable via a mechanism that involves a single wavelength of excitation light, the wavelength of the one or more excitation light projections can be the same.

In cases in which a photohardenable composition is photohardenable via a mechanism that involves more than wavelengths of excitation light, the excitation lights will be selected to include appropriate wavelengths (or ranges of wavelengths) for the mechanism.

Preferably method and systems described herein include irradiation with excitation light from two light sources, such two excitation light sources can be included in separate optical systems. A first system, preferably a light sheet generating system, can generate and direct a light sheet including a first wavelength to a selected location in the volume, and a second optical system, preferably a projection system including a projector and a second light source for projecting an optical image (e.g., a two-dimensional cross-sectional slice of an object to be printed or other two-dimensional image) including a second wavelength of light. Depending on the hardening mechanism of the photohardenable composition being used, the first and second wavelengths can be the same or different. For example, for a photohardenable composition including a dual-wavelength photoinitiator, the first and second wavelength are typically different. The optical image and light sheet may be arranged such that they are projected to intersect or overlap at the selected location, preferably in a coplanar manner. The light sheet and optical image are preferably directed into the volume in directions orthogonal with respect to one another. The optical image is preferably orthogonal to the direction along which it is directed into the volume.

A light sheet can be constructed by means known in the art including, for example, but not limited to, techniques including a laser and a Powell lens, galvanometer, and/or polygon scanning mirror. Alternatively, one or more LEDs can be used as a light source.

A light sheet generating system can include a light source of a first excitation light including a first wavelength, preferably a laser, from which a light sheet is generated by a light sheet generator. The light sheet generating system can also preferably include further light sheet optics between the light sheet generator and the container.

A projection system for generating an optical image can be selected to apply continuous excitation light. An optical system can be selected to apply intermittent excitation light. Intermittent excitation can include random on and off application of light or periodic application of light. Examples of periodic application of light includes pulsing. An optical system can be selected to apply a combination of both continuous excitation light and intermittent light, including, for example, an irradiation step that includes the application of intermittent excitation light that is preceded or followed by irradiation with continuous light.

A projection system can further include one or more additional components including, but not limited to, one or more translational stages for moving the system or components thereof.

A projection system can include a projector such as a spatial light modulator (e.g., a DMD) and a light source in combination with illumination optics to illuminate the DMD. Such illumination optics can optionally comprise beam conditioning and condenser optics and relay optics. A light source for a second excitation light including a second wavelength illuminates the projection device. A light source comprising a non-pulsed laser or a continuous wave laser can be preferred. A projection system can further include projection optics positioned between the projector and the container. Projection optics can be used for magnifying and projecting a focused optical projection of excitation light into the container. Optionally, prism(s) can be positioned between the spatial light modulator and the illumination and projection optics. A projected image (typically a 2-dimenstional cross-section slice of the object to be printed) is projected to the selected focal plane at the selected location in the volume. The optical image is preferably orthogonal to the direction in which it is projected into the volume.

Examples of spatial light modulators (which may also be referred to as projector devices or projection devices) for use in the methods and systems described herein may include, but are not limited to, a laser projection system, a liquid crystal display (also referred to herein as “LCD”), a spatial light modulator (also referred to herein as “SLM”) (for example, but not limited to, a digital micromirror device (also referred to herein as “DMD”) or a digital light processing device (also referred to herein as “DLP”)), a micro-LED array, a vertical cavity laser array (also referred to herein as “VCL”), a Vertical Cavity Surface Emitting Laser array (also referred to herein as “VCSEL”), a liquid crystal on silicon (also referred to herein as “LCoS”) projector, and a scanning laser system. (Light emitting diode is also referred to herein as “LED”.)

Examples of light sources of the excitation light that may be suitable for use in various aspects of the present invention including light sources include, by way of example and non-limitation, lasers, laser diodes, light emitting diodes, light-emitting diodes (LEDs), micro-LED arrays, vertical cavity lasers (VCLs), and filtered lamps. Such light sources are commercially available and selection of a suitable light source can be readily made by one of ordinary skill in the relevant art. Laser light sources can be preferred.

Optionally, the excitation light can be temporally and/or spatially modulated. Optionally, the intensity of the excitation light can be modulated. Optionally, source drive modulation can be used to adjust the absolute power of the light beam, especially when synchronized with the scanner oscillation, where the intensity of the final light sheet can be precisely modulated along the height dimension of the light sheet.

A configuration of a projector device and light source can optionally further include one or more optical components (e.g., projection optics, illumination optics, lenses, lens systems, mirrors, prisms, etc.)

A projection system may also be referred to herein as an optical projection system. A projector may also be referred to herein as a projector device.

Preferably the directions in which the light sheet and optical image are directed to the selected location in the volume are orthogonal to each other with the optical image and light sheet intersecting or overlapping in a coplanar manner.

In embodiments in which excitation light is projected from two light sources into container, the photohardenable composition is at least partially hardened, polymerized, or cross-linked at the intersection region of the light sheet and optical image from two light sources. By moving the intersection through volume of the photohardenable composition included in the container, a 3D object may be created from photohardenable composition. In such embodiments, the intersection may be moved with respect to container. In other embodiments, the intersection may be fixed, and container may be moved in order to form one or more 3D objects in the container. In other embodiments, both the container and the light sheet can be moved relative to each other.

A photohardenable composition typically includes a photohardenable resin component and a photoinitiator.

A photohardenable composition preferred for use in the various aspects of the present invention preferably includes a photohardenable resin component and a dual wavelength photoinitiator.

Dual wavelength photoinitiators for inclusion in a photohardenable composition for use in the present invention preferably possess photochromic properties and can be converted to a second form upon irradiation with light of a first wavelength, which second form can be converted to back to the first form upon irradiation with light of a second wavelength, process of cycling between these forms capable of inducing a crosslinking or polymerization reaction in the photohardenable resin component. The conversion of the photoswitchable photoinitiators described herein to a second form of the molecule (e.g., an isomer thereof) is preferably a reversible photochemical structural change. (Dual wavelength photoinitiators including such photochromic properties are also referred to herein as “photoswitchable photoinitiators”.)

Several considerations in selecting a particular photoswitchable photoinitiator for inclusion in a photohardenable composition or method in accordance with the present invention include, by way of example, but not limited to, the absorption spectra and Amax of the molecule and its second forms, the solubility of the photoswitchable photoinitiator in the photohardenable resin component, the photoinitiation sensitivity of the first and second forms of the photoswitchable photoinitiator, the amount of initial concentration of the second form in the monomer solution, the stability of the photoswitchable photoinitiator and the reduction and oxidation potentials of the second form of the photoswitchable photoinitiator.

Preferred photoswitchable photoinitiators include, but are not limited to, photochromic molecules, (e.g., but not limited to, a benzospiropyran molecule, a naphthopyran molecule, a spironaphthoxazine molecule, a diarylethene molecule) which photochromic molecules can more preferably include one or more functional groups attached thereto. Such photochromic molecules can undergo a reversible intramolecular transformation forming an active form of the molecule by irradiation (photochromic). Such preferred photoswitchable photoinitiators, e.g., in the case of benzospiropyrans, naphthopyrans, and spironaphthoxazines, can function by light activated opening of the photoswitchable photoinitiator to form the activated form upon exposure to a first wavelength. In the case of diarylethenes, the activation process instead involves a ring-closing. The colored form may subsequently absorb light of a different second wavelength to cycle the switch back to the initial uncolored form. The process of cycling the photoswitchable photoinitiator between these forms may subsequently induce photoinitiation, either alone or in combination with a coinitiator (e.g., amine, thiol, organoborate compounds, onium salts).

Preferred photohardenable compositions including a photoswitchable photoinitiator are particularly suitable for use in the methods of the present invention for forming three-dimensional objects. The photoswitchable photoinitiator molecule in its initial form and the photoinitiator molecule in its activated second form can have sufficiently distinct absorption spectra that once the initial form of the molecule is activated form, the activated form absorbs in a wavelength region where the initial form is minimally absorbing. In this way, the activated form can be independently excited with the second wavelength without causing unintended excitation of the initial form by the second wavelength. The second wavelength can excite the activated form to cycle the photoswitchable photoinitiator back to the initial form. The initial form can further absorb the first wavelength and undergo further cycling, where the desired hardening of the photohardenable resin occurs preferably at regions where both first and second wavelengths are coincident and cause the most rapid cycling and therefore the most rapid photoinitiation of the photoswitches.

Information concerning photohardenable compositions and photoswitchable photoinitiators that may be useful in connection with the various aspects of the present invention includes International Application No. PCT/US2022/037491, filed Jul. 18, 2022, of Quadratic 3D, Inc., International Application No. PCT/US2022/042179, filed Aug. 31, 2022, of Quadratic 3D, Inc., International Application No. PCT/US2022/042183, filed Aug. 31, 2022, of Quadratic 3D, Inc., International Application No. PCT/US2022/042186, filed Aug. 31, 2022, of Quadratic 3D, Inc., each of the foregoing applications being hereby incorporated herein by reference in its entirety.

Additional examples of photoswitchable photoinitiators suitable for inclusion in a photohardenable composition useful in the present invention are described in International Application No. PCT/US2023/022170 of Quadratic 3D, Inc. filed May 13, 2023, and International Application No. PCT/US2023/022173 of Quadratic 3D, Inc. filed May 13, 2023, each of which is hereby incorporated herein by reference in its entirety.

Examples of preferred dual wavelength photoinitiators for use in the methods of the present invention include substituted or unsubstituted P-type photochromic molecules. Examples of such preferred photoinitiators include, but are not limited to, substituted or unsubstituted diarylethene molecules. See, for example, International Application No. PCT/US2023/022172 of Quadratic 3D, Inc. filed May 13, 2023.

A photohardenable resin component suitable for inclusion in a photohardenable composition can comprise any resin (e.g., a monomer, an oligomer, a pre-polymer, a polymer, or a mixture including at least one the foregoing) that is photohardenable by exposure to light in the presence of a photoinitiator. Examples of photohardenable resin components useful for inclusion in a photohardenable composition include ethylenically unsaturated compounds and, more specifically, a polyethylenically unsaturated compounds. These compounds include both monomers having one or more ethylenically unsaturated groups, such as vinyl or allyl groups, and polymers having terminal or pendant ethylenic unsaturation. Such compounds are well known in the art and include, but are not limited to, acrylic and methacrylic esters of polyhydric alcohols such as trimethylolpropane, pentaerythritol, and the like; and acrylate or methacrylate terminated epoxy resins, acrylate or methacrylate terminated polyesters, etc. Representative examples include, but are not limited to, ethylene glycol diacrylate, ethylene glycol dimethacrylate, trimethylolpropane triacrylate (TMPTA), pentaerythritol tetraacrylate, pentaerythritol tetramethacrylate, dipentaerythritol hydroxypentacrylate (DPHPA), hexanediol-1,6-dimethacrylate, and diethyleneglycol dimethacrylate. Preferred examples include, but are not limited to, a urethane acrylate or a urethane methacrylate.

A photohardenable resin component can optionally comprise one or more multifunctional acrylate monomers. Dipentaerythritol pentaacrylate, a pentafunctional acrylic monomer available from Sartomer as SR399 is an example of a photohardenable resin component that may be desirable for inclusion in photohardenable composition of the present invention.

Aliphatic urethane acrylates may also be desirable for use as a photohardenable resin component for inclusion in a photohardenable composition described herein.

Mixtures of multifunctional acrylate monomers, such as dipentaerythritol pentaacrylate (e.g., SR399 from Sartomer), and aliphatic urethane acrylates can also be used.

A photohardenable resin component including other mixtures including one or more resin components can also be useful.

Preferably, the photohardenable resin component included in a photohardenable composition is selected to achieve an optically transparent medium, which is desirable in processes and systems in which light, e.g., excitation light, is directed into the composition or light.

Examples of particularly preferred photohardenable resin components include, but are not limited to, free-radical-polymerizable resins, cross-linkable resins, multifunctional acrylate monomers, methacrylates, aliphatic urethane acrylates, and the like.

Optionally a solvent, preferably, for example, but not limited to, an acrylamide monomer or an acrylate monomer, can be further included in a composition described herein for mixing the photoswitchable photoinitiator in the photohardenable resin component. Other suitable solvents may also be used.

A photohardenable composition can optionally include a coinitiator. (A coinitiator can also be referred to as a synergist). Optionally, one or more coinitiators can be included.

Suitable coinitiators include coinitiators which are reducing agents, oxidizing agents, or hydrogen donating compounds.

Examples of coinitiators that may be useful can be selected from among those known in the art and, more particularly, tertiary amines and organoborate salts. Iodonium salts may also be useful, particularly in combination with a borate salt. In certain embodiments, an iodonium salt may also be included in combination with a tertiary amine. Examples of other useful electron donating coinitiators are discussed by Eaton, D. F., “Dye Sensitized Photopolymerization”, Advances in Photochemistry, Vol. 13, pp 427-486.

Representative examples of N,N-dialkylanilines useful in the present invention as coinitiators include 4-cyano-N,N-dimethylaniline, 4-acetyl-N,N-dimethylaniline, 4-bromo-N,N-dimethylaniline, 4-methyl-N, N-dimethylaniline, 4-ethoxy-N,N-dimethylaniline, N,N-dimethylthioanicidine, 4-amino-N,N-dimethylaniline, 3-hydroxy-N, N-dimethylaniline, N,N,N,′N,-tetramethyl-1,4-dianiline, 4-acetamido-N,N-dimethylaniline, 2,6-diethyl-N,N-dimethylaniline, N,N,2,4,6-pentanethylaniline (PMA) and p-t-butyl-N,N-dimethylaniline.

Certain other tertiary amines are also useful coinitiators including triethylamine, triethanolamine, N-methyldiethanolamine, 2-ethyl-4-(dimethylamino)benzoate, 2-ethylhexyl-4-(dimethylamino)benzoate, etc.

Another class of useful coinitiators includes alkyl borate salts such as ammonium salts of borate anions of the formula BR^{a}R^{b}R^{c}R^{d} wherein R^{a}-R^{d} are independently selected from the group consisting of alkyl, aryl, alkaryl, allyl, aralkyl, alkenyl, alkynyl, alicyclic and saturated or unsaturated heterocyclic groups. Representative examples of alkyl groups represented by R^{a}-R^{d} are methyl (Me), ethyl, propyl, butyl, pentyl, hexyl, octyl, stearyl, etc. The alkyl groups may be substituted, for example, by one or more halogen, cyano, acyloxy, acyl, alkoxy or hydroxy groups. Representative examples of aryl groups represented by R^{a}-R^{d} include phenyl, naphthyl and substituted aryl groups such as anisyl and alkaryl such as methylphenyl, dimethylphenyl, etc.

Representative examples of aryl groups represented by Ra-Rd include benzyl. Representative alicyclic groups include cyclobutyl, cyclopentyl, and cyclohexyl groups. Examples of an alkynyl group aryl propynyl and ethynyl, and examples of alkenyl groups include a vinyl group. Preferably, at least one but not more than three of R^{a}, R^{b}, R^{c}, and R^{d} is an alkyl group. Each of R^{a}, R^{b}, R^{c}, and R^{d} can contain up to 20 carbon atoms, and they typically contain 1 to 7 carbon atoms. More preferably R^{a}-R^{d} are a combination of alkyl group(s) and aryl-group(s) or aralkyl group(s) and still more preferably a combination of three aryl groups and one alkyl group, i.e., an alkyltriphenylborate, e.g., but not limited to, a butyltriphenyl borate.

A photohardenable composition can optionally include a sensitizer. Optionally, one or more sensitizers can be included.

A sensitizer can create the excited state of the photoswitchable photoinitiator via absorbing light and transferring energy to the photoswitchable photoinitiator. For example, a sensitizer can control the sensitivity of the composition and extend the spectral sensitivity of the closed form of the photoswitchable photoinitiator. Useful sensitizers include those known in the art such as acetophenone, benzophenone, 2-acetonaphthone, isopropyl thioxanthone, alkoxyketocoumarins, Esacure 3644, and the like.

Optionally, a composition described herein can include one or more coinitiators and one or more sensitizers.

A photohardenable composition for use in the methods of the present invention preferably display non-Newtonian rheological behavior. Such rheological behavior can facilitate forming an object in a volume of a photohardenable composition upon exposure to at least two different wavelengths of excitation light wherein the object remains at a fixed position or is minimally displaced in the volume of the unhardened composition during formation. Minimal displacement refers to displacement of the object being formed during its formation in the volume that is acceptable for precisely producing the intended part geometry. Such rheological behavior can also facilitate separation of the partially hardened object from the volume in which it is formed upon application of stress. While not wishing to be bound by theory, upon the application of stress, the apparent viscosity of the non-Newtonian composition can drop to a lower value (e.g., the steady shear viscosity) than the static value (e.g., zero shear viscosity or yield stress) allowing the unhardened composition to more easily flow off and separate from the object. Examples of such non-Newtonian rheological behavior include but are not limited to pseudoplastic fluid, yield pseudoplastic, Bingham plastic, Bingham pseudoplastic rheological behavior.

Non-Newtonian rheological behavior can be imparted to a photohardenable composition by further including one or more reactive components (e.g. urethane acrylate oligomers, urethane methacrylate oligomers, acrylated or methacrylated polyurethanes, acrylated or methacrylated polyurethane-ureas, acrylated or methacrylated polyesters, acrylated or methacrylated polyamides, acrylate- or methacrylate-functional block copolymers, alkenyl- or alkynyl-functional urethane oligomers, alkenyl- or alkynyl-functional polyurethanes, alkenyl- or alkynyl-functional polyurethane-ureas, alkenyl- or alkynyl-functional polyesters, alkenyl- or alkynyl-functional polyamides, alkenyl- or alkynyl-functional block copolymers, thiol-functional urethane oligomers, thiol-functional polyurethanes, thiol-functional polyurethane-ureas, thiol-functional polyesters, thiol-functional polyamides, thiol-functional block copolymers) in the photohardenable resin component and/or by further adding one or more nonreactive additives (e.g., but not limited to, one or more thixotropes and/or rheology modifiers) to the composition. Selection of the one or more of reactive components and the amounts thereof for addition to a photohardenable resin component included in a photohardenable composition to impart non-Newtonian rheological behavior thereto is within the skill of the skilled artisan in the relevant art without undue experimentation. Similarly, selection of nonreactive additives and the amount(s) thereof for addition to the photohardenable composition to impart non-Newtonian rheological behavior thereto is within the skill of the skilled artisan of the relevant art without undue experimentation.

A photohardenable composition described herein can preferably have a steady shear viscosity, for example, which is less than 30,000 centipoise, less than 20,000 centipoise, less than 10,000 centipoise, less than 5,000 centipoise, less than 1,000 centipoise. (Steady shear viscosity refers to the plateau value of the viscosity achieved with unidirectional constant shear, e.g., the value of the viscosity after the thixotrope network has broken up.) Steady shear viscosities may be measured at ambient (e.g., room temperature), printing temperature, or some other temperature (e.g., elevated or reduced). Measurement at printing temperature may provide advantage in determining the suitability of a photohardenable composition for printing. Preferred steady shear viscosities are less than 30,000 centipoise, more preferably less than 10,000 centipoise, and most preferably less than 1,000 centipoise.

Steady shear viscosity can be measured under continuous constant-rate shear, such as at shear rates ranging from about 0.00001 s⁻¹ to about 1000 s⁻¹.)

Photohardenable compositions can further include one or more additives. Examples of additives include, but are not limited to, a filler, a thixotrope/rheology modifier, a defoamer, a stabilizer, an oxygen scavenger, a non-reactive solvent diluent, a thermally activated radical initiator, and a colorant. Any additive can be a single additive or a mixture of additives. For example, a thixotrope can comprise a single thixotrope or a mixture of two or more thixotropes. Additional information concerning additives and non-limiting examples thereof are provided below.

Additives are preferably selected so that they do not react with other components or additives that may be included in photohardenable compositions.

As mentioned above, one example of an additive that may be included in photohardenable compositions includes a filler. Optionally a filler can include a combination of one or more fillers. A fillers can be included in an amount greater than 0 to about 90 weight percent, the amount being determined by the purpose for the filler and the desired end use characteristics for the intended three-dimensional object. Advantageously, fillers may be selected to maintain the optical transparency of the photohardenable composition, e.g., by controlling particle size to be substantially less than the excitation wavelengths or by matching the refractive indices of the filler and matrix to reduce optical scatter.

Fillers may be used to modify the properties of a hardened photohardenable composition, for example the stiffness, strength, toughness, impact resistance, resistance to creep, resistance to fatigue, mechanical energy return, mechanical loss tangent, glass transition temperature, thermal degradation temperature, thermal conductivity, thermal resistance, moisture uptake, electrical conductivity, static dissipation, dielectric constant and loss tangent, density, refractive index, optical dispersion, opacity to ionizing radiation, and resistance to ionizing radiation. Fillers may also be used to modify the properties of the liquid (e.g., unhardened) photohardenable composition, such as rheological properties such as viscosity and thixotropy and optical properties such as refractive index. Examples of fillers include but are not limited to silica, alumina, zirconia; silicates glasses such as soda-lime glass, borosilicate glass, sodium silicate glass, lead glass, aluminosilicate glass, barium glass, thorium glass, glass ceramics; chalcogenide glasses; glass microspheres and microbubbles; nanoclays such as laponite, montmorillonite, bentonite, kaolinite, hectorite, and halloysite; calcium phosphate minerals such as hydroxyapatite, mineral fillers such as chalk, rock dust, slag dust, fly ash, hydraulic cement, loess, limestone, kaolin, talc, and wollastonite. Examples of particle size ranges include but are not limited to less than 10 microns, less than 1 micron, 10 nm to 500 nm, 10 nm to 90 nm, 40 nm to 70 nm. Smaller particles sizes, in particular sizes less than about 100 nm, may be beneficial to provide high optical clarity of the liquid composition to better facilitate printing. Controlling the particle size distribution, for example monodisperse, bimodal, or trimodal distributions of sizes, may be beneficial to control rheological properties, increase filler weight percent, or modify the properties of a photohardenable composition.

Other examples of additives that may be included in photohardenable compositions include a thixotropes and rheology modifiers. Thixotropes and rheology modifiers suitable for inclusion in a photohardenable composition described herein include, for example and without limitation, urea derivatives; modified urea compounds such as Rheobyk 410 and Rheobyk-D 410 available from BYK-Chemie GmbH, part of the ALTANA Group; fumed metal oxides (also referred to as pyrogenic metal oxides) including for example, but not limited to, fumed silica, fumed alumina; zirconia; precipitated metal oxides including for example, but not limited to, precipitated silica, precipitated alumina; unmodified and organo-modified phyllosilicate clays; dimer and trimer fatty acids; polyether phosphates; oxidized polyolefins; hybrid oxidized polyolefins with polyamide; alkali soluble/swellable emulsions; cellulosic ethers; hydrophobically-modified alkali soluble emulsions; hydrophobically-modified ethylene oxide-based urethane; sucrose benzoate; ester terminated polyamides; tertiary amide terminated polyamides; polyalkyleneoxy terminated polyamides; polyether amides; acrylamidomethyl-substituted cellulose ester polymers; polyethyleneimine; polyurea; organoclays; hydrogenated castor oil; organic base salts of a clay mineral (e.g., montmorillonite) and other silicate-type materials; aluminum, calcium, and zinc salts of fatty acids, such as lauric or stearic acid.

See U.S. Pat. Nos. 6,548,593 of Merz, et al., issued Apr. 15, 2003, and 9,376,602 of Walther, et al. issued Jun. 28, 2016, which are hereby incorporated herein by reference in their entireties, for information relating to urea derivatives that may be useful as thixotropes.

Thermally reversible gellants such as ester terminated polyamides, tertiary amide terminated polyamides, polyalkyleneoxy terminated polyamides, and polyether amides, and combinations thereof, may be desirable for us as thixotropes. Examples include Crystasense LP1, Crystasense LP2, Crystasense LP3, Crystasense MP, Crystasense HP4, Crystasense HP5, Rheoptima X17, Rheoptima X24, Rheoptima X38, Rheoptima X58, Rheoptima X73, and Rheoptima X84 available from Croda. Crystasense HP-5 is a preferred example of a thixotrope.

Metal oxides that have been surface-treated to impart dispersibility characteristics compatible with a photohardenable composition described herein may be desirable for use as thixotropes.

A thixotrope can be included in a photohardenable composition in an amount, for example, in a range from about 0.05 weight percent to about 15 weight percent, from about 0.5 weight percent to about 15 weight percent, from about 0.5 weight percent to about 10 weight percent from about 1 to about 10 weight percent of the composition. Other amounts may also be determined to be useful.

A thixotrope is preferably included in a photohardenable composition in an amount effective to restrict movement of the three-dimensional object or one or more regions thereof in the photohardenable composition during formation.

More preferably, the thixotrope is included in a photohardenable composition in an amount effective to restrict movement of the three-dimensional object suspended (without contact with a container surface) in the volume of composition during formation. Most preferably the position of the object in the volume of the photohardenable composition remains fixed position during formation of the object.

Optionally, a photohardenable composition can further include a light activated photoinitiator as described in International Application No. PCT/US2023/022171 of Quadratic 3D, Inc., filed 13 May 2023, which is hereby incorporated herein by reference in its entirety. Preferably such photoinitiator is not appreciably responsive to light of a first wavelength or second wavelength. Inclusion of a photoinitiator can be desirable in connection with optional post-processing that includes, for example, a post-curing step involving exposure of the printed object to UV light after printing.

Another example of additives that can be included in a photohardenable composition includes defoamers. A defoamer can be included to aid in removing bubbles introduced during processing and handling. A preferred defoamer is BYK 1798 (a silicone based defoamer) available from BYK-Chemie GmbH, part of the ALTANA Group.

Another example of additives that can be included in a photohardenable composition includes a stabilizer. A stabilizer can be included to improve shelf-life of the composition and/or to control the level of cure and/or spatial resolution during printing. An example of preferred stabilizer is TEMPO (2,2,6,6-tetramethylpiperidinooxy free radical available from Sigma-Aldrich). Examples of other stabilizers include, but are not limited to, hindered phenols such as butylated hydroxytoluene; hydroquinone and its derivatives such as hydroquinone methyl ether; hindered amine light stabilizers; alkylated diphenylamines; and phosphite esters.

Optionally an additive comprising a non-reactive solvent diluent can be included. Examples include, but are not limited to, acetone, amyl acetate, n-butanol, sec-butanol, tert-butanol, butyl acetate, cyclohexanone, decane, dimethylacetamide, dimethylformamide, dimethylsulfoxide, dipropylene glycol, dipropylene glycol methyl ether, ethanol, ethyl acetate, ethylene glycol, glycerol, heptane, isopropanol, isopropyl acetate, methyl ethyl ketone, N-methyl pyrrolidone, propylene carbonate, propylene glycol, propylene glycol diacetate, tetrahydrofuran, tripropylene glygol methyl ether, toluene, water, xylenes.

It may also be desirable to include a thermally activated radical initiator in a photohardenable composition. Thermally activated radical initiator examples include but are not limited to 2,2′-azobis(2-methylpropionitrile), 1,1′-azobis(cyclohexanecarbonitrile), 2,2′-azobis [N-(2-carboxyethyl)-2-methylpropionamidine] n-hydrate, 2,2′-azobis [2-methyl-N-(2-hydroxyethyl) propionamide], organic peroxides, inorganic peroxides, peroxydisulfate salts.

Unless otherwise indicated, specified weight percents are based on the total weight of the photohardenable composition.

The nature of a photohardenable resin component, the amount of the dual wavelength, and, when applicable, a coinitiator, a sensitizer, a thermally activated radical initiator, or other optional additive, included in photohardenable compositions will vary with the particular use of the compositions, the emission characteristics of the exposure sources, the development procedures, the physical properties desired in the hardened product and other factors.

The methods in accordance with various aspects of the invention can further include post-treatment of the three-dimensional object(s) formed.

Examples of post-treatments include, but are not limited to, removing the formed three-dimensional object from the container. Following removal from the container, the completed object can be further processed. Examples of further processing include, without limitation, washing, post-curing (e.g., by light, e-beam, heat, non-ionizing radiation, ionizing radiation, time (aging), pressure, humidity, or simultaneous or sequential combinations of techniques), metrology, labelling or tracking (e.g., by barcode, QR code, or RFID tag), freeze-dry processing, critical point drying, and packaging.

Preferably photoswitchable photoinitiators useful in methods for printing 3D objects in accordance with the present invention can absorb first wavelength light from about 300 nm to about 550 nm. Other examples of ranges in which the photoswitchable photoinitiator will absorb first wavelength light include, but are not limited to, from about 350 to about 460 nm, from about 350 to about 455 nm, from about 350 nm to about 445 nm, from about 350 nm to about 410 nm, from about 375 to about 455 nm, from about 375 to about 445 nm, from about 375 nm to about 405 nm. Other examples are described herein. Depending upon the extinction coefficient for the particular photoswitchable photoinitiator, the conversion to the second form can be induced by exposure to any source which emits in this range, e.g., lasers, light emitting diodes, mercury lamps. Filters may be used to limit the output wavelengths. A non-limiting example of filtered light includes filtered emission from a mercury arc lamp, etc. Lasers can be preferred sources of radiation for generating radiation of the first wavelength.

The second form of the photoswitchable photoinitiator will preferably absorb second wavelength light in a range of about 450 nm to about 1000 nm, and from about 450 nm to about 850 nm most typically. Other examples of ranges in which the second form of the photoswitchable photoinitiator will preferably absorb second wavelength light include from about 450 nm to about 700 nm. This form can be activated by the second excitation light to cycle the switch back to the initial form. The process of cycling the switch between the forms may generate free radicals directly or through electron transfer or hydrogen abstraction (optionally via electron, hydrogen, or energy transfer to coinitiator(s) in aspects of the invention including one or more coinitiator). For the second excitation, exposures may be accomplished using a laser source, an LED or LED array, the filtered emission from an arc lamp, or other suitable source with emission within the desired wavelength range. argon ion, He-Ne, laser diodes, krypton, frequency-multiplied Nd-YAG, etc. Other light sources may be used, optionally with filters to limit output wavelengths, e.g., light emitting diodes, incandescent lamps, halogen lamps, mercury lamps, arc lamps, etc. Lasers can be preferred sources of radiation for generating radiation of the second wavelength.

As used herein a wavelength can refer to a wavelength or range of wavelengths.

Excitation light may be visible light, ultraviolet light, or other suitable forms of electromagnetic radiation.

In methods described herein, each wavelength is preferably generated by a different light source or different optical projection or other optical systems.

The radiation or excitation source is preferably selected to emit radiation at a wavelength or within a range of wavelengths absorbed by the particular photoinitiator, e.g., the photoswitchable photoinitiator.

In methods described herein, exposure energies of excitation light directed into the volume of photohardenable composition may be, without limitation, in a range from about 0.01 to about 100,000 mJ/cm² (inclusive).

When first and second wavelengths are included in a method or system, examples of power examples of exposure energies for the first wavelength light include exposure energies in a range from about 0.001 to about 1,000 mJ/cm² (inclusive) and examples of exposure energies for the second wavelength light include exposure energies in a range from about 0.01 to about 100,000 mJ/cm² (inclusive).

Other exposure energies may also be determined to be useful.

In methods described herein, power densities or intensities of excitation light directed into the volume of photohardenable composition may be, without limitation, in a range from about 0.01 to about 100,000 W/cm².

When first and second wavelengths are included in a method or system, examples of power densities for the first wavelength light include power densities in a range from about 0.01 to about 100,000 W/cm² (inclusive) and examples of power densities for the second wavelength light include power densities in a range from about 0.01 to about 100,000 W/cm² (inclusive).

Other power densities or intensities may also be determined to be useful.

In the methods described herein, the container optionally may be rotated to provide additional angles of illumination or projection of excitation light into the volume of photohardenable composition contained therein. This can be of assistance in patterning object volumes or surfaces more accurately or it can be used as a means of providing multiple exposure of a given feature from different angles.

In the method described herein, the container optionally may be stationary while a beam or optical projection of excitation light is being directed into the volume of the printing composition. Alternatively, the position of the container may be translated or moved during excitation while a beam and/or optical projection of excitation is being directed into the volume of the printing composition.

Other information that may be useful in connection with the various aspects of the present inventions includes International Application No. PCT/US2022/052157, filed Dec. 7, 2022, of Quadratic 3D, Inc., and International Application No. PCT/US2022/039766, filed Aug. 9, 2022, of Quadratic 3D, Inc., each of the foregoing applications being hereby incorporated herein by reference in its entirety.

Before printing, a digital file of the object or object to be printed is obtained. If the digital file is not of a format that can be used to print the object, the digital file is then converted to a format that can be used to print the object. An example of a typical format that can be used for printing includes, but is not limited to, an STL file. Typically, the STL file is then sliced into two-dimensional layers with use of three-dimensional slicer software and converted into G-Code or a set of machine commands, which facilitates building the object. See B. Redwood, et al., “The 3D Printing Handbook-Technologies, designs applications”, 3D HUBS B.V. 2018.

Other information concerning optical systems that may useful in connection with the various aspects of the present inventions includes Texas Instruments Application Report DLPA022-July 2010 entitled “DLP™ System Optics”; Texas Instruments “TI DLR Technology for 3D Printing-Design scalable high-speed stereolithography [sic] systems using TI DLP technology” 2016; Texas Instruments “DLP6500 0.65 1018p MVSP Type A DMD”, DLP6500, DLPS040A-October 2014—Revised October 2016; and Y-H Lee, et al., “Fabrication of Periodic 3D Nanostructuration for Optical Surfaces by Holographic Two-Photon-Polymerization”, Int'l Journal of Information and Electronics Engineering, Vol 6, No. 3, May 2016, each of the foregoing being hereby incorporated herein by reference in its entirety.

The 3D printing method described herein does not require adhering the object being printed to a fixed substrate (e.g., build plate) at the beginning of the printing process avoiding a post-processing step of separating the printed object from the fixed substrate. It additionally facilitates printing three-dimensional objects in a volume of photopolymerizable liquid without requiring support structures to form a printed object. Post-processing steps of removing support structures and/or removing the printed object from a fixed substrate add labor (e.g., manual removal), waste (discarded support structures), and reduce throughput (a build plate cannot be reused until the printed object is removed), all of which add cost to the process.

When used as a characteristic of a portion of a container or build chamber, “optically transparent” refers to having high optical transmission to the wavelength of light being used, and “optically flat” refers to being non-distorting (e.g., optical wavefronts entering the portion of the container or build chamber remain largely unaffected).

As used herein, the singular forms “a”, “an” and “the” include plural unless the context clearly dictates otherwise. Thus, for example, reference to an emissive material includes reference to one or more of such materials.

As used herein, the singular of “a”, “an”, and “the” include plural unless the context clearly dictates otherwise. Thus, for example, reference to a photoinitiator includes reference to one or more photoinitiators.

Applicant specifically incorporates the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the present invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1. A method comprising:
(a) printing a three-dimensional object in a volume of a photohardenable composition, wherein printing the three-dimensional object includes exposure of a series of selected locations in the volume to a light sheet and a selected projected optical image using a set of preliminary printing settings; and
(b) determining deflection of a light sheet profile during printing the three-dimensional object using the set of preliminary printing settings.

2. The method of claim 1 further comprising:
(c) correlating the determined light sheet deflection profile to one or more of the preliminary printing settings to determine one or more modifications to the preliminary printing settings for use in subsequently printing one or more three-dimensional objects in the volume of the photohardenable composition.

3-10. (canceled)

11. The method of claim 2 wherein one or more of the preliminary printing settings are modified to adjust the determined light sheet deflection profile within a selected range during subsequent printing of the one or more three-dimensional objects in the volume.

12. (canceled)

13. The method of claim 1 wherein printing settings include one or more of printing exposure time for a given selected location, power level of a projector included in generating the selected projected optical image for the given selected location, power level of a light sheet generator included in generating the light sheet for the given selected location, thickness of the light sheet for the given selected location.

14-15. (canceled)

16. The method of claim 2 further comprising subsequently printing the one or more three-dimensional objects in the volume of the photohardenable composition using the modified preliminary printing settings in which one or more of the preliminary printing settings have been modified to adjust light sheet deflection profile for the subsequent printing of the one or more three dimensional objects.

17. (canceled)

18. The method of claim 16 wherein light sheet deflection during the subsequent printing of the one or more three-dimensional objects in the photohardenable composition using the modified preliminary printing settings is re-determined before reusing the photohardenable composition to print one or more additional three-dimensional objects.

19. (canceled)

20. The method of claim 16 wherein deflection of the light sheet during the printing of the one or more three-dimensional objects in the volume is determined and correlated to the modified set of printing settings to determine any further modifications of the modified set of printing settings before reusing the photohardenable composition to print one or more additional three-dimensional objects.

21. The method of claim 16 wherein variation of the light sheet profile during a subsequent printing of the one or more three-dimensional objects in the volume is determined and correlated to the modified set of printing settings to determine any further modifications of the modified set of printing settings before reusing the photohardenable composition to print one or more additional three-dimensional objects.

22. (canceled)

23. The method of claim 16 further comprising removing the three-dimensional object printed with use of the set of preliminary printing settings from the volume before printing the one or more three-dimensional objects in the volume.

24. The method of claim 16 further comprising repeating steps (b) and (c) for the one or more three-dimensional objects subsequently printed with the modified preliminary printing settings to determine light sheet deflection for the one or more subsequently printed part to determine any further changes to one or more of the modified printing settings before a next print.

25. The method of claim 24 further comprising one or more successive subsequent prints wherein steps (b) and (c) are repeated for each successive subsequent print.

26. The method of claim 24 wherein maintaining the light sheet deflection profile within a selected range for one or more reuses of the photohardenable composition to print three-dimensional objects is used to assess run-to-run printing consistency for the three-dimensional objects printed in the one or more reuses of the photohardenable composition.

27. The method of claim 25 further including maintaining light sheet deflection profile within a selected range for a reuse of the photohardenable composition to print three-dimensional objects.

28-43. (canceled)

44. The method of claim 2 wherein the volume of the photohardenable composition is included in a three-dimensional volumetric printing system, and wherein the method further comprises:
generating modified printing settings for printing the one or more three-dimensional objects in the volume, wherein the modified printing settings include the preliminary printing settings including the one or more determined modifications for adjusting the light sheet deflection profile for use in printing one or more three-dimensional objects therewith; and
communicating the modified printing settings to the three-dimensional volumetric printing system.

45. The method of claim 44 further comprising executing the modified printing settings by the three-dimensional volumetric printing system to print the one or more three-dimensional objects in the volume of the photohardenable composition.

46-53. (canceled)

54. A volumetric 3D printing system comprising:
(a) a volumetric 3D printer including a container for containing a volume of a photohardenable composition, light sheet optics configurable for directing a light sheet to a selected location in the volume of the photohardenable composition, projection optics configurable for projecting a selected optical image to the selected location in the volume to print a three-dimensional object in a volume of the photohardenable composition including sequential exposure of a series of selected locations in the volume to a light sheet and a series of projected optical images using a selected set of printing settings;
(b) a controller for controlling the printer for printing the one or more three-dimensional objects using the set of selected printing settings; and
(c) a detector for capturing a light sheet profile of the three-dimensional object being printed after exposure of the photohardenable composition to the light sheet and the projected optical image at the selected location.

55. The volumetric 3D printing system of claim 54 wherein the detector includes a surface comprising a charge coupled device sensor onto which the light sheet profile is imaged.

56. The volumetric 3D printing system of claim 54 wherein the detector includes an imaging screen for receiving an image of the light sheet profile and an imaging device for recording the light sheet profile.

57-72. (canceled)

73. The method of claim 1 wherein the photohardenable composition includes a photohardenable resin component and a photoinitiator

74. The method of claim 73 wherein the photoinitiator comprises a dual wavelength photoinitiator.

75. The method of claim 73 wherein the dual wavelength photoinitiator comprises a photoswitchable photoinitiator.

76. The method of claim 73 wherein the photohardenable composition further includes a coinitiator.

77. (canceled)

78. The method of claim 73 wherein the photohardenable composition demonstrates non-Newtonian rheological behavior.

79. The method of claim 1 wherein the light sheet is generated with a first excitation light including a first wavelength with a first power density and first exposure energy and the projected optical image is generated with a second excitation light including a second wavelength with a second power density and second exposure energy.

80-90. (canceled)

91. The method of claim 23, wherein the three-dimensional object printed with the use of the set of preliminary printing settings comprises a calibration part.
